(19) United States
(12) Patent Application Publication
(10) Pub. No.: US 2005/0283425 A1
(43) Pub. Date: Dec. 22, 2005

(54) Scalable auction management system with centralized commerce services

(76) Inventors: Russell Grove, Etowah, TN (US); Randall Wharton, Etowah, TN (US); Nathan Brown, Etowah, TN (US)

Correspondence Address: DOUGLAS T. JOHNSON;MILLER & MARTIN, 1000 VOLUNTEER BUILDING, 832 GEORGIA AVENUE, CHATTANOOGA, TN, 37402-2289, US

(21) Appl. No.: 11/073,273

(22) Filed: Mar. 4, 2005

Related U.S. Application Data
(60) Provisional application No. 60/550,994, filed on Mar. 5, 2004.

(51) Int. Cl. G06F 17/60

(52) U.S. Cl. 705/37

(57) ABSTRACT

A system and method is provided for the scaleable sale of consigned items into an online auction marketplace with a plurality of intake nodes handling item intake, identification, description, warehousing, and post auction shipping, while a centralized commerce center uploads auction information to the marketplace, receives auction results and buyer payments, and provides shipping data to the intake nodes. The system is optimized to automate and facilitate operations handled at the intake nodes, while an enterprise level database and software applications are utilized to manage back office functions of the consignment network in an efficient and scalable fashion.

The present application claims priority to U.S. Patent Application Ser. No. 60/550,994 filed on Mar. 5, 2004.

### FIELD OF THE INVENTION

The present invention relates to a system to facilitate selling in online auction marketplaces, with centralized commerce services, but distributed intake locations.

### BACKGROUND OF THE INVENTION

The Internet has proved an effective medium by which buyers can purchase an enormous variety of goods. Typically, a customer selects a product from a seller over the Internet, such as from a web-based storefront or in an online marketplace, and completes the transaction electronically, except for the delivery of the goods or services. One of the most interesting developments in this form of electronic commerce has been the growth of online auctions, the largest of which is eBay (www.ebay.com). The eBay online service permits sellers to list items for sale, buyers to bid on items of interest, and all eBay users to browse through listed items in a fully automated, topically arranged service. Through its PayPal service, eBay also enables any business or consumer with email and a financial account to send or receive online payments. Online auction websites have made the process of purchasing listed items relatively straightforward and not significantly different from making purchases from online storefronts. However, the process of listing items for sale in an online auction remains relatively complex and is probably beyond the interest or ability of all but 5% to 10% of the population.

As the online auction marketplace grew, the difficulty in listing items was initially addressed by individuals providing auction assistance to interested sellers. In addition, a variety of software tools have been developed and offered by a number of companies to facilitate the listing process and monitoring auctions. With these tools, small retail establishments, such as pawn shops, are able to create listings for selected inventory items, auction those items through an online auction marketplace, receive payment and ship the items to purchasers.

From this, it was only a short step to the creation of consignment storefronts, such as TIAS.com and myEZsale.com, which each had several locations at the height of the dot.com boom in 2000. These consignment stores operated as individual business units with virtually no synergy other than branding and marketing through the opening of multiple locations. This has been the template for many subsequent Internet auction consignment stores. One minor variation has been the hub and spoke organization of Auction Drop which has established a number of drop-off centers in the San Francisco Bay Area. The drop-off centers are staffed by only one or two employees who intake items from consignors. Once the items have been processed at the drop-off center, they are transported to a central processing center to be photographed and listed on the eBay auction site. As Auction Drop has expanded, it has been faced with a choice of building additional hubs to support each group of drop-off storefronts or to engage in shipping from drop-off storefronts to its existing hubs. In either case, the hub and spoke model involving the actual transport of consigned items from drop-off center to a processing center entails additional item handling and shipping costs.

It is therefore desirable to provide a scalable model for online consignment sales that does not entail unnecessary shipping of items to centralized facilities.

### BRIEF DESCRIPTION OF THE INVENTION

The present invention includes software tools and processes necessary to overcome the challenges inherent in online auction sales. The system solves the complex issues of creating and maintaining a large number of online auctions: tying the computer, digital image capture, auction creation, and item specific knowledge together in one utility. In addition to allowing a single entity to sell products online in quantity, remote locations called storefronts can be run from a dedicated centralized commerce center. Centralized functionality allows individual locations to concentrate on the customer experience and quickly receiving an item and creating (posting) an auction online, as on eBay. The entire auction creation process is streamlined to a three or four minute task. The storefront location places the item on a light table, automatically focuses the camera and captures images of the item. Image files are automatically edited, formatted, and compressed for publishing on the web before automatically uploading via FTP to a centralized web server. Through a parallel process the item is described using a knowledge base. Shipping criteria are input and shipping charges based on storefront location are calculated and formatted for web viewing. This process takes only three or four minutes, after which the item data is transmitted to centralized commerce center to be compiled with auctions from other storefronts and posted under a common brand. While an auction is active, the commerce center manages customer inquiries, answering process related questions and forwarding item-specific inquiries to the originating storefront. After the auction has ended seven (7) days later the system automatically generates an email taking the buyer through online auction checkout process. The commerce center automatically collects payment through PayPal, the primary payment vehicle, also managing other types of preferably electronic payments. Collected funds are electronically transferred and a complete history of the transaction/sale is compiled and stored on the central server. Shipping information is sent from the commerce center to the storefront location where the item will be packed and shipped. Post-sale feedback is provided by the commerce center at this time. The system allows scaling to unlimited size without high-end computer systems, detailed item knowledge, and digital photo editing skills sets at storefront locations.

### BRIEF DESCRIPTION OF THE DRAWINGS

FIG. 1 is a flow chart of steps of a typical online auction process showing the allocation of steps of the process between a storefront and a centralized back office.

FIG. 2 is a diagramic illustration of steps of an online auction process and the allocation of steps between a storefront and centralized commercial services back office.

FIG. 3 is an overview of the features and processes of the system.

FIG. 4 is a detailed flow chart of the consignor information process.

FIG. 5 is a detailed flow chart showing the consignment entry process.

FIG. 6 is a flow chart of the image capture process.

FIG. 7 is a detailed flow chart of the photo process.

FIG. 8 is a flow chart of the FTP image management process.

FIG. 9 is a flow chart of the process for automating the production of a listing description.

FIG. 10 is a detailed flow chart of the description authoring process.

FIG. 11 is a detailed flow chart showing the process for category determination for a listing item.

FIG. 12 is a detailed flow chart showing the process for shipping determination.

FIG. 13 is a flow chart of the autopost process for auction posting.

FIG. 14 is a detailed flow chart of the end of day data compilation process.

FIG. 15 is a high level organizational chart showing the processes provided in centralized commerce services.

FIG. 16 is a detailed flow chart of a high bidder notification process.

FIG. 17 is a detailed flow chart of a payment collection process.

FIG. 18 is a detailed flow chart of a pickup scheduling process.

FIG. 19 is a detailed flow chart of a shipment notification process.

FIG. 20 is a detailed flow chart of a process of generating shipping documentation.

FIG. 21 is a high level flow chart of a warehousing process.

FIG. 22 is a detailed flow chart of a warehouse check-in process.

FIG. 23 is a detailed flow chart of a warehouse check-out process.

FIG. 24 is a detailed flow chart of the return of unsold items process.

FIG. 25 is a detailed flow chart of an inventory control process.

FIG. 26 is a representative computer screen display for entry of consignor information.

FIG. 27 is a representative computer screen display listing items and item identifiers.

FIG. 28A is a representative data entry screen for image data.

FIG. 28B is a representative computer display screen with raw image data captured.

FIG. 28C is a representative computer display with edited image data.

FIG. 29A is a representative item description data entry screen.

FIG. 29B is a representative data entry screen displaying an initial knowledge base functionality.

FIGS. 29C and 29D are displays of FIG. 29B with more advanced tree flow knowledge functionality.

FIG. 29E is a representative description screen of FIG. 29A substantially populated by use of the knowledge base.

FIG. 30 is a representative screen display showing data captured as necessary to comply with eBay's online auction listing format.

FIG. 31A is a representative screen display of a data entry screen utilized for quality tracking.

FIG. 31B is a representative screen display of a report of quality tracking data.

FIG. 32 is a representative screen display of email utilizing a knowledge base for common communications.

FIG. 33A is a representative screen display for an email notice to a successful buyer at the conclusion of auction.

FIG. 33B is a representative payment screen for a successful buyer in an eBay auction.

FIG. 34 is a representative screen display for electronic payment by a successful buyer utilizing the PayPal service.

FIG. 35A is a representative data entry screen for extraction of PayPal data.

FIG. 35B is a representative screen display showing extraction of PayPal data to populate order and shipping documentation.

FIG. 35C is a representative screen display showing the resulting capture of buyer information from the process of FIGS. 35A and 35B.

FIGS. 36A-36C are representative screen displays showing batch processing of orders to shipping documents.

FIGS. 37A and 37B are representative screen displays for tracking production by product manager.

FIG. 38 is a representative screen display of consignor reporting.

FIG. 39 is a representative screen display showing consignor relationship reporting available to the consignor online.

FIG. 40 is a diagramic overview of the locations for physical and electronic communications according to the invention.

### DETAILED DESCRIPTION OF THE DRAWINGS

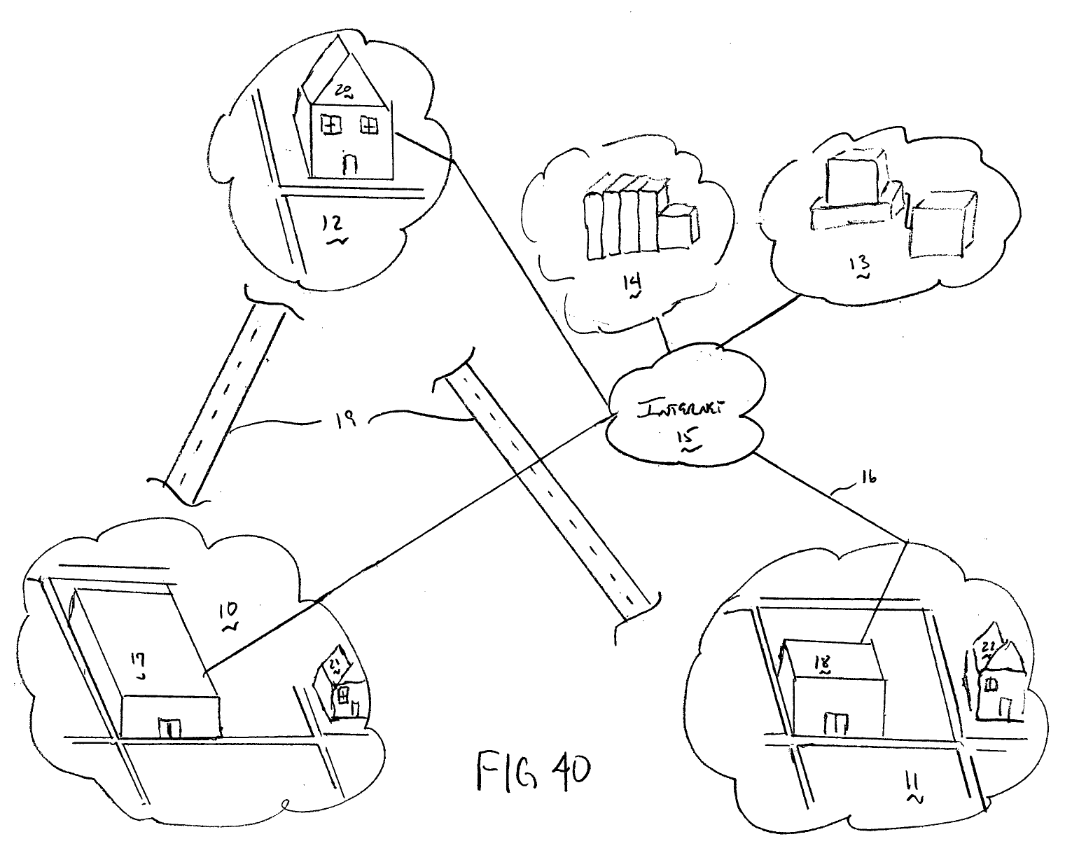

Referring first to FIG. 40, a general overview of the operation of the system can be provided. Represented in FIG. 40 is a first community 10 with a storefront or intake facility 17 and a first consignor location such as residence 21. It will be understood that consignors may be individuals, businesses, charitable organizations, government entities, or virtually any person or organization with goods to be sold. Similarly, a second community 11 includes a second storefront or intake node 18 and a second consignor location such as residence 22. Yet a third community location 12 includes a buyer location such as house 20, although buyers may include virtually any type of business or organization with a need to acquire goods. The centralized commerce services as described in greater detail below are hosted at one or several locations 13. Preferably, central commerce hosting may be centralized at a single location with backup, or possibly at two geographically diverse locations in different time zones to provide both redundancy and to facilitate spanning across a broader range of business hours.

Finally, location 14 represents the servers hosting online auction marketplace. The intake nodes 17, 18, buyer 20, central commerce center 13, and online auction provider 14 are all connected by communication links 16 with the network of autonomous systems that comprises the Internet 15. The consignors in communities 10, 11 need not be connected to the Internet. Instead, consignors travel to the storefront 17, 18 in their respective community 10, 11. At the storefront, consignor contact information is recorded, a unique identifier is assigned to each item that is consigned, the item is photographed, information is taken from the consignor and through examination of the consigned goods with the aid of a knowledge base and automated authoring solution, a product description is generated. The product description and images are associated with the item identifier, auction specifics such as shipping costs, listing categories, and length and type of auction are recorded. Then this information is communicated electronically over the Internet from storefront 17, 18 to central commerce center 13 where the process of actually transmitting the auction listing information to the online auction provider 14 is completed. During the auction, email inquiries from potential buyers are addressed to the central commerce center 13. At auction close, central commerce center 13 generates appropriate notices, collects payments, generates reports and electronically transmits shipping label data to storefront 17, 18. The consigned items bearing identifying labels have remained at storefront 17, 18 during the auction, and upon receipt of shipping details and confirmation of payment from central commerce services, storefront 17, 18 retrieves the consigned articles, packages and ships those articles by conventional delivery channels such as ground delivery service using highways 19 to purchasers such as buyer in community 12. Thus, there is no unnecessary shipment of physical items, but by transmitting information concerning consigned items electronically to central commerce center 13, the great majority of data processing and reporting activity may be managed centrally utilizing powerful scalable software solutions and recognizing significant economies of scale with respect to the provision of centralized commerce services to the storefront, 17, 18.

Turning then to FIG. 1, this process is illustrated in flow chart form with storefront level processes 100 and centralized commerce services 110. At the community storefront or intake node level principal steps in the process involve consignment intake 101, item image capture and processing 102, description authoring utilizing knowledge base and autowriter routine 103 and file transfer 104 to central commerce services. At central commerce services 110, the principal steps include review of information from storefront and handling the actual auction posting 111, managing buyer inquiries, notifying auction winners and providing checkout of payment information 113, collecting payment 114, collecting buyer data and reporting the completed transaction to storefront 114, 115.

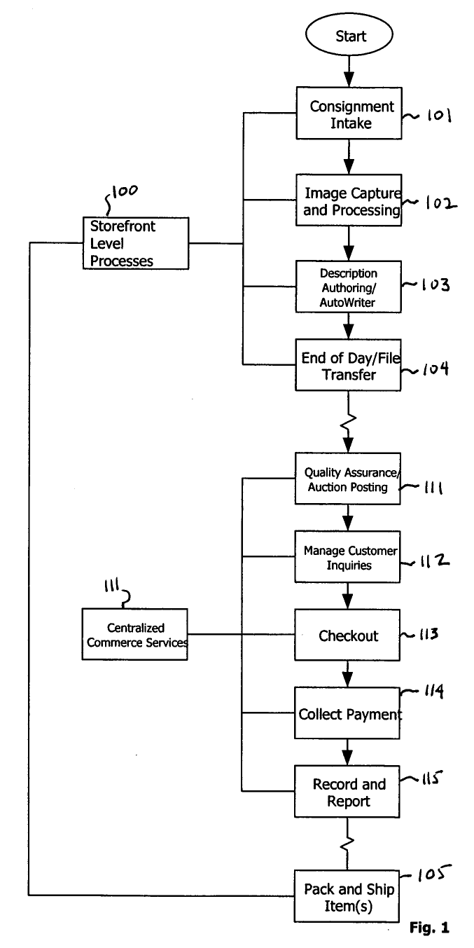

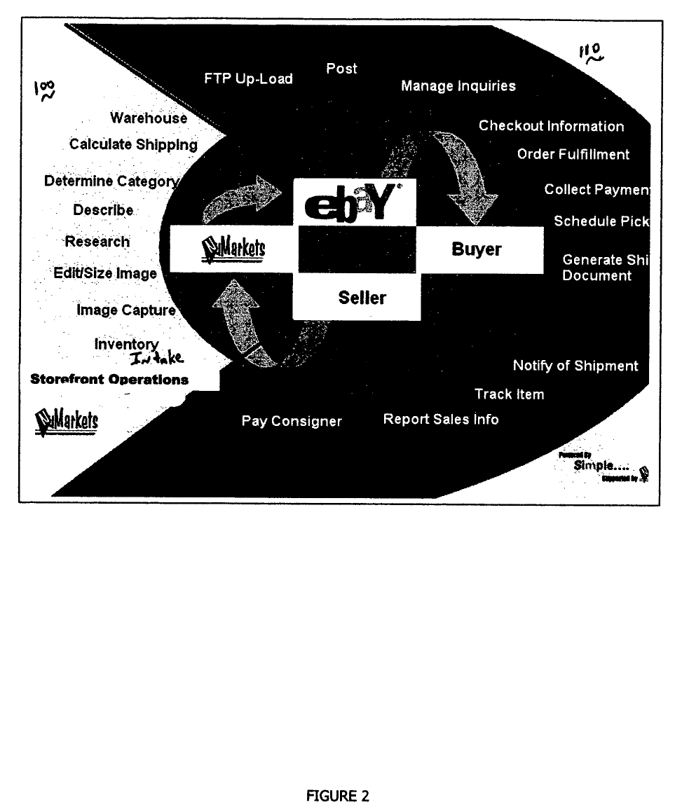

FIG. 2 displays the same general relationship with storefront services 100 and centralized commerce services 110.

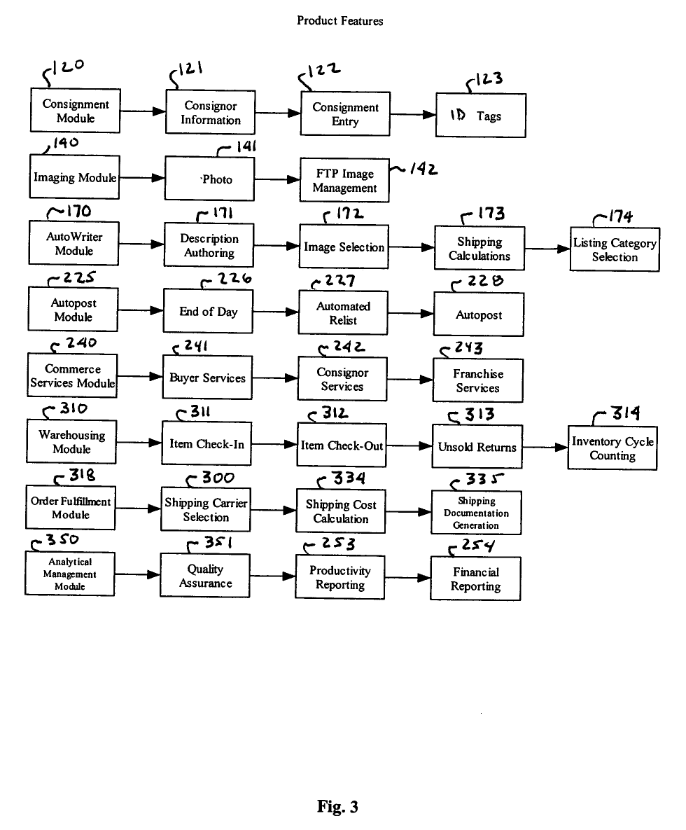

As shown in FIG. 3, the system is comprised of several modules, processes and utilities, each concerned with a different aspect of the online auction process as presented by a managing complex process across multiple storefronts or intake points. There are several primary modules that contain individual task specific utilities. These individual modules are responsible for collecting, archiving, manipulating, and communicating data between storefronts and a central server. The centralized data organization structure leverages a post-relational database utilizing proven interfaces and provides a vehicle for efficient process management across multiple locations.

Consignment Module. The Consignment Module 120 consists of three (3) applications which provide the specialized tools necessary to create, maintain and scale online auctions across multiple storefront locations/franchises. Consignor Information 121, Consignment Entry 122, and ID Tags 123 comprise a unique application module and process that provides data-entry, organization, and manipulation tools not otherwise available.

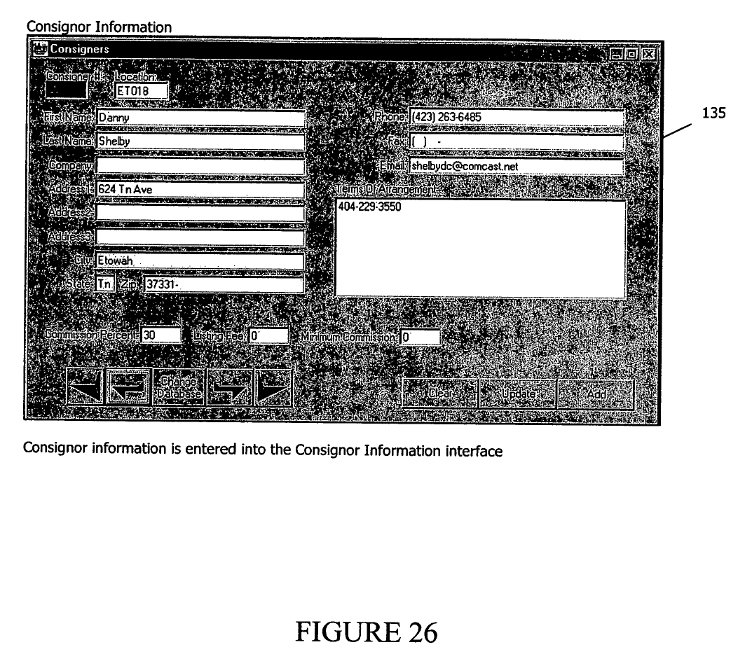

Consignor Information 121 provides a customer (Consignor) organization tool uniquely suited to the needs presented by managing Consignors across a nation/worldwide platform without the need for specialized hardware. Consignor Entry functions as a visual interface allowing the intake node operator to create a unique entry in multiple databases throughout the system. The unique entry 135, typified by FIG. 26, functions as the structural foundation and reference for intra-company communications and customer relations management.

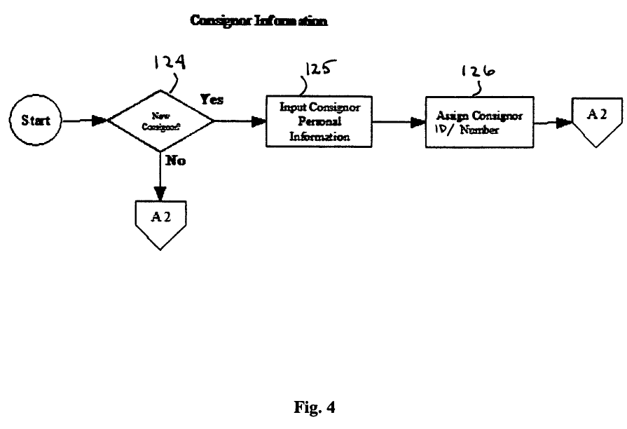

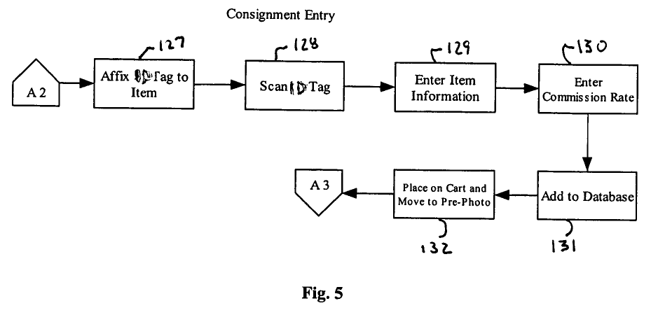

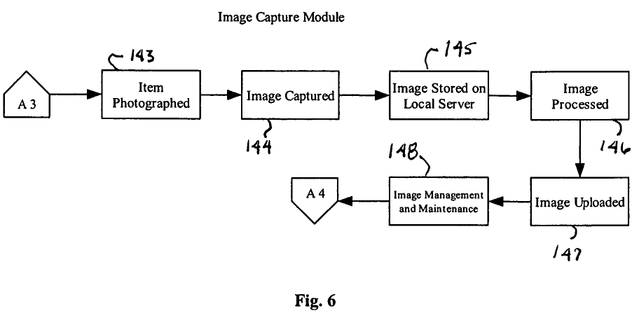

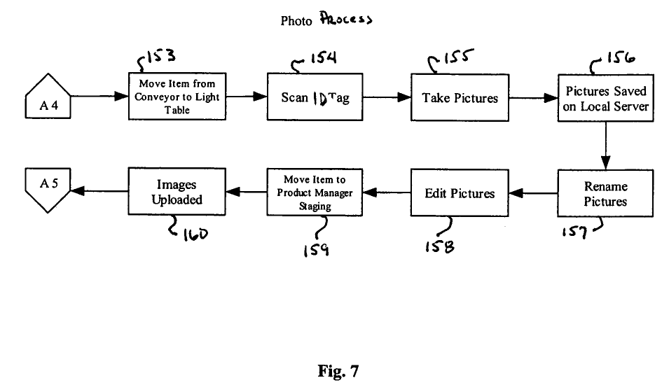

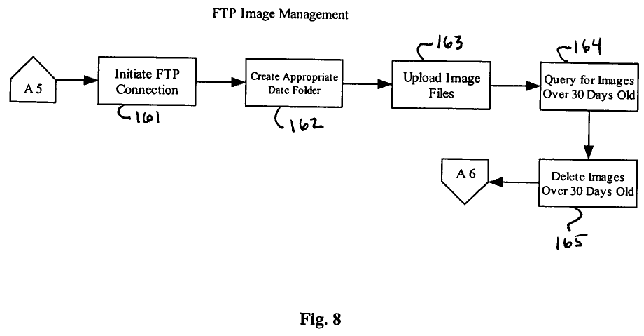

The Consignor Information 121 module is shown in FIG. 4 and is used to enter new consignors into the database. The module assigns a unique I.D. (Consignor Number) to each Consignor based on a request to the central database. Consignor information is stored at the storefront database and the central database. Each new consignor is assigned a unique I.D. 126 that serves as an identifier for that consignor for the life of the relationship. The Consignor Number is used from that point forward to identify the consignor and the consignors items at all levels of communication. New consignors provide personal information 125 such as name, street address, driver's license number, phone number, and email address as typified by data entry form 135 in FIG. 26. This information is stored in the local and central database and is referenced by the Consignor Number. Any Items the consignor brings in can be referenced by the Consignor Number. The Consignor Number also provides a reference for automated reporting and payment of consignors.

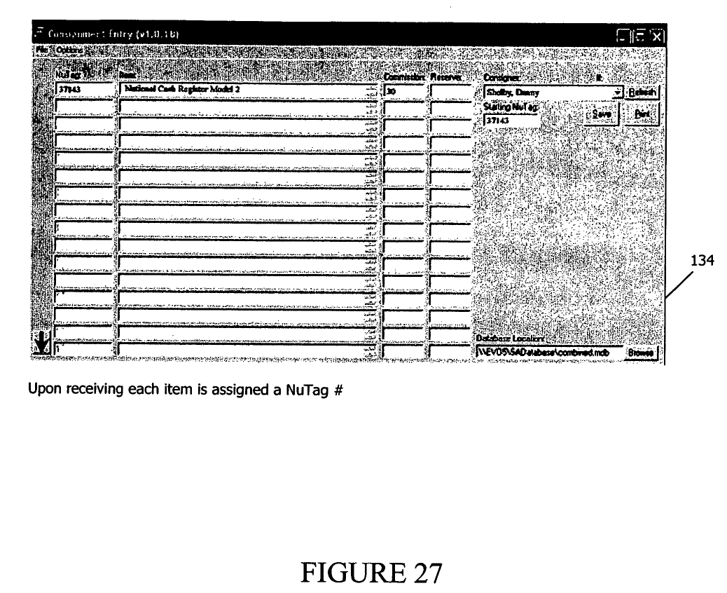

Consignment Entry. Consignment Entry 122 functions as a data-entry and organizational tool managing, across multiple locations, the large quantities of item-specific information present in creating and managing large numbers of online auctions. This unique tool allows the creation of an online auction of extraordinarily high-quality and attention to detail not available elsewhere. Consignment Entry, as shown in FIG. 27, is used to enter information about individual consignment items into the database. A unique identifier (an ID Tag or as used by the assignee NuMarkets, a NuTag) is applied to each incoming item at the time it is received 127. The ID Tag is used as a reference 128 to that item from that point forward. Item specific information, notes, (what it is, provence. how old it is, manufacturer, etc.) are entered into the database here 129 as well. This provides a customer approved reference for use by intake personnel or “Product Managers” dealing with the customer/consignors at the storefronts and dispute settlement. Should a consignor choose to apply a Reserve Price to the item the Reserve Price is entered at this time. The commission rate is determined and entered 130 as on form 134 in FIG. 27 at this time as well. Depending on consignor selected options the commission rate may vary. The commission rate is used after the sale during the Consignor Payment process.

ID Tags. ID Tags are unique inventory identifiers, preferably generated in Code 39 barcode format with human-readable summary information or may be RFID enabled. The ID Tags provide a link between the item, the consignor, the images, the warehouse location, to the consignor report. An ID Tag is applied to each item at the time it is received. Each ID Tag should contain storefront location information and a storefront location specific item number issued in ascending order. The storefront may preferably be identified by a unique three (3) letter abbreviation and is followed by the item number in human readable form. Utilizing a standardized Automated Data Collection (ADC) system with unique data content, provides the basis for an infinitely scalable inventory management system.

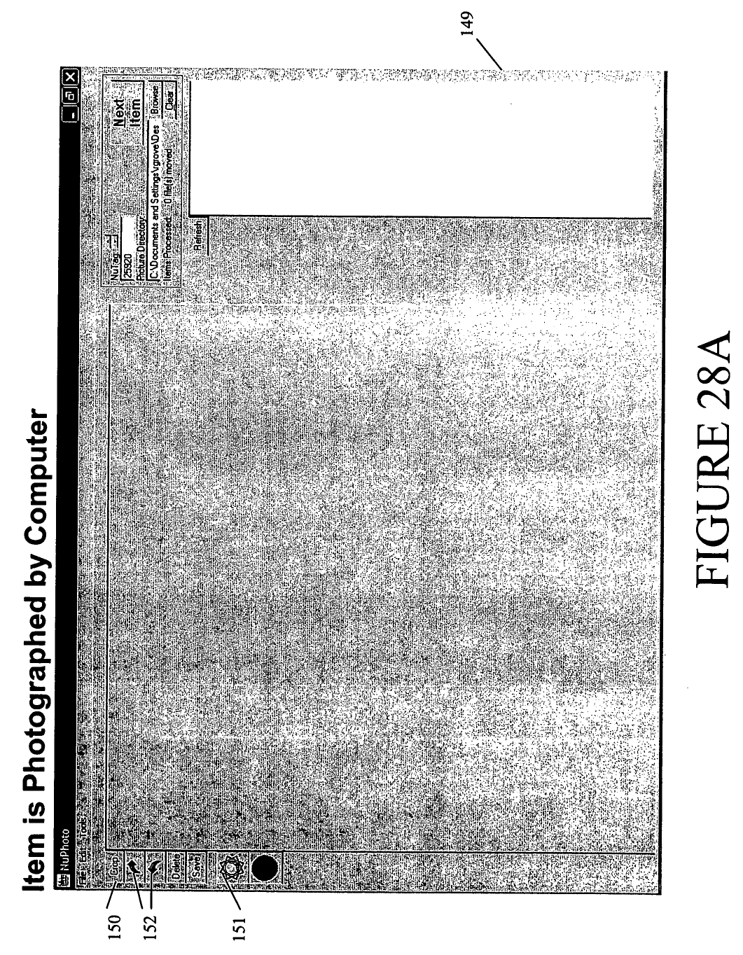

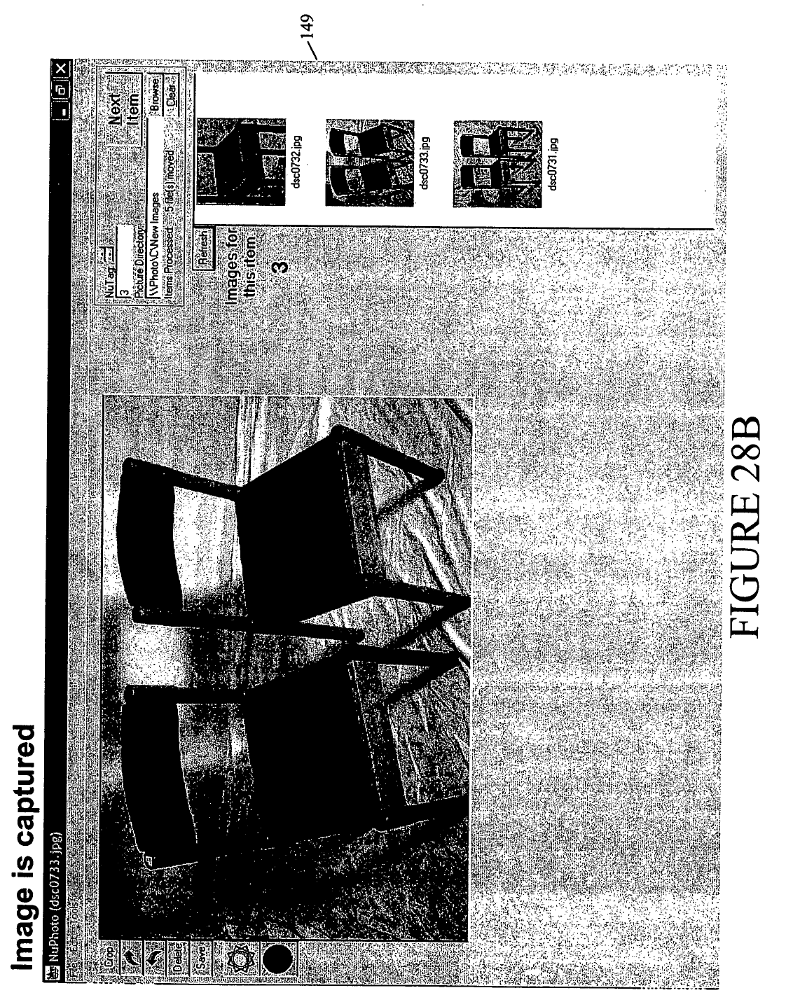

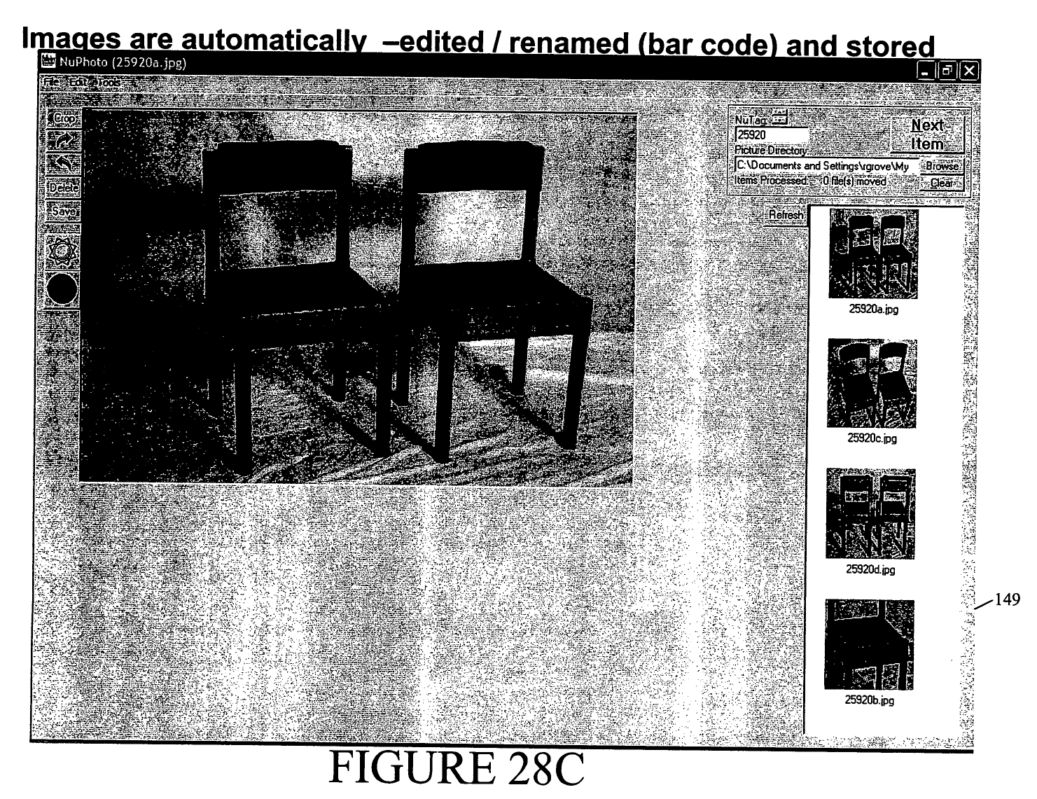

Imaging Module. The system image capture tools represent a comprehensive restructuring of the traditional image capture and editing processes. Photographing 143 followed by automated image capture 144 and file formatting and a simplified image editing interface 146 with integration into Autowriter, via the ID Tag, provide substantial momentum to the overall auction creation process. The image capture tools reflected in the forms of FIGS. 28A-28C show how it is possible to eliminate the need for employees formally trained in digital photography and image editing.

Photo. The Photo module 141 functions as the core utility in the image capture and editing process. Compiling the image capture and editing process streamlines the overall amount of labor and equipment required to produce high-quality digital images. Direct file transfer alleviates the need for removable camera media and provides a conduit for direct image editing and file transfer. The abridged editing interface on display 149 provides controls for commonly used editing tools and removes extraneous tools not necessary within the scope online auctions. The system's imaging interface allows storefront locations to fill the photographer position with available talent as opposed to recruiting specialized employees.

The Photo module 141 is used to capture and process images sent from the digital camera. The item's ID Tag is scanned 154, pictures taken 155 and then the Photo module 141 captures, edits, renames, saves 156, and uploads images 160, as via FTP. Preferably, incoming JPG format images are captured via a USB port and displayed in the Photo interface of FIG. 28 as shown on screen display 149 where brightness 151, contrast and orientation 152 can be manipulated 158 in order to obtain optimal image quality. As shown in FIG. 28B, images can also be cropped 150; controlling proportionality and extraneous content in oddly shaped/oversized items. Image files are renamed 157 to coincide with the ID Tag number of the relevant item. Files are saved in a dated directory on the local server. Files are then compressed and ready for FTP uploading, as reflected in FIGS. 28A through 28C.

FTP Image Management. The FTP utility 142 within the imaging module 140 functions as a semi-automated file transfer and management program that can be operated without specialized web publishing knowledge. Carrying out image management as an automated process allows the storefront location to focus on low/no technology processes.

The system is configured with FTP utilities to allow connection initiation 161 and uploading to the image file server 163 immediately after processing. Images from completed auctions are removed from the image file server 165 via automated FTP after a predetermined period 164 in order to maximize storage space. The FTP server file system contains a virtual directory where uploaded files are hosted according to storefront and date 162.

Autowriter Module. The system provides an autowriter that is a compilation of utilities permitting a single intake user, or Product Manager, to create a complete auction in an eBay or other auction compatible format and communicate the information between the storefront location and the central commerce database. Product Managers are responsible for collecting the specific data necessary to create each auction using the automated system. Product Managers utilize information obtained about the item from the consignor combined with a collapsing menu knowledge base to construct a comprehensive description of the item including its condition, construction materials, and other physical factors. The Autowriter module 170 reduces the description writing time using pre-written content provided by a technical writer, managing the item into best listing categories, and coordinating image retrieval and viewing. The single-user auction creation environment forms a streamlined process and provides a vehicle for managerial analysis tools such as user productivity, accountability and process improvement.

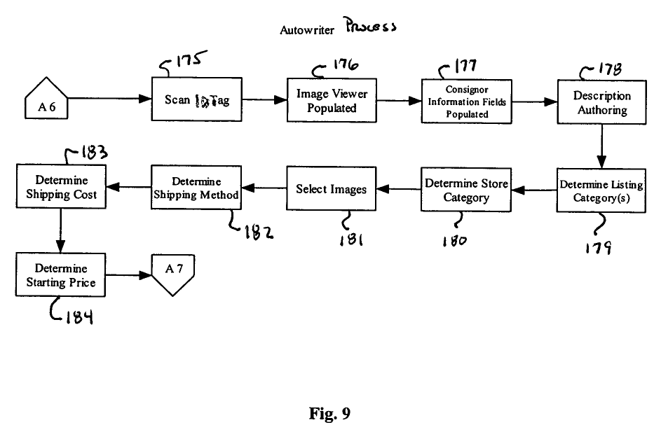

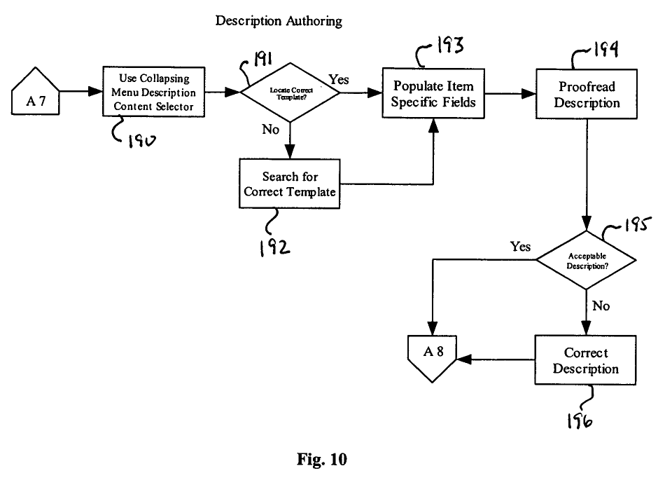

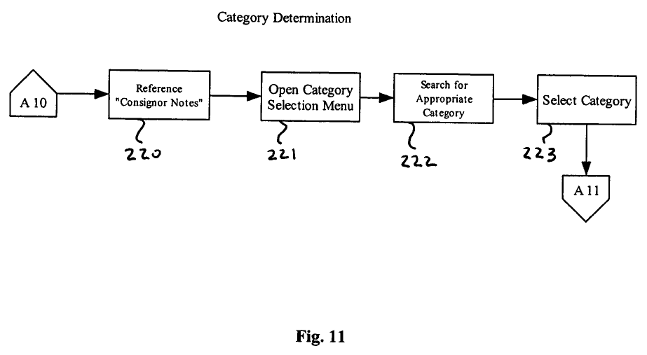

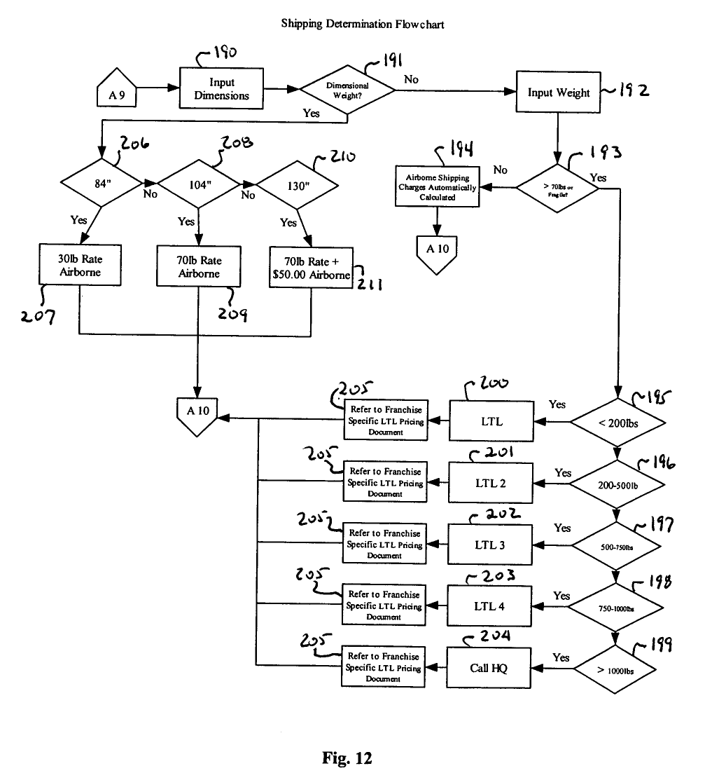

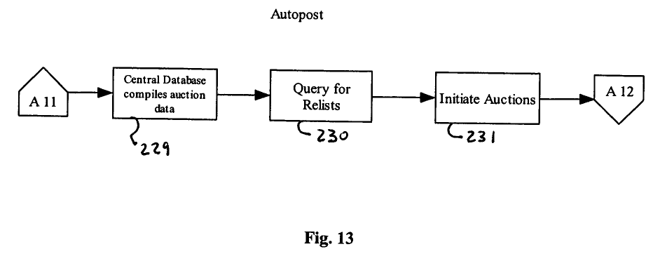

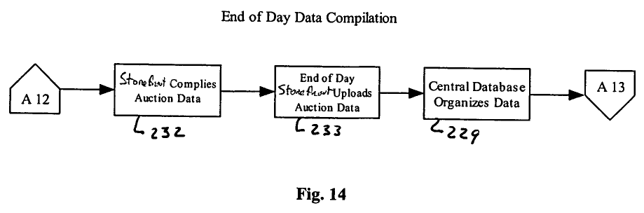

The autowriter processes are shown in Autowriter module 170 as shown in greater detail in FIG. 9. The process begins with scanning an item's ID Tag 175 which results in the automatic population of the screen display with previously photographed images of the item 176 and consignor information fields 177. Then the item description is authored 178 utilizing the autowriter and dynamic knowledge base as explained in greater detail in connection with FIG. 10. An appropriate category listing is determined 179 as shown in greater detail in FIG. 11, as well as an eBay store category 180. The user will also select from the populated images 181 to determine the most prominently displayed photographs. Then shipping method 182 and cost 183 are determined as shown in greater detail in FIG. 12 and the starting price for the item is determined and entered 184.

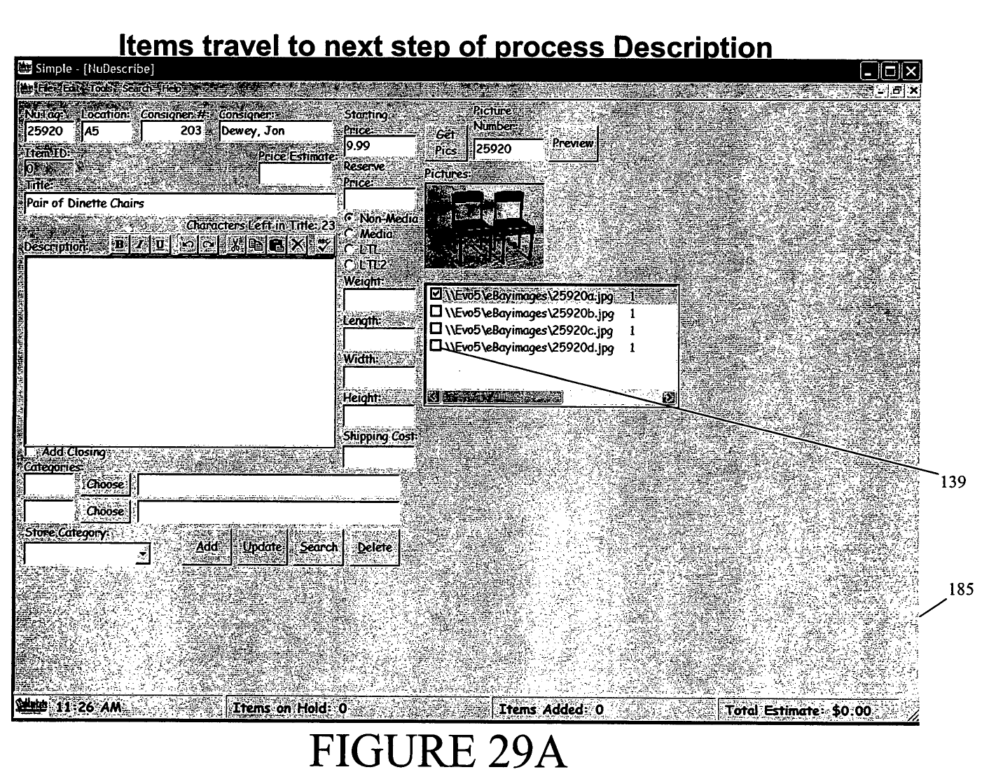

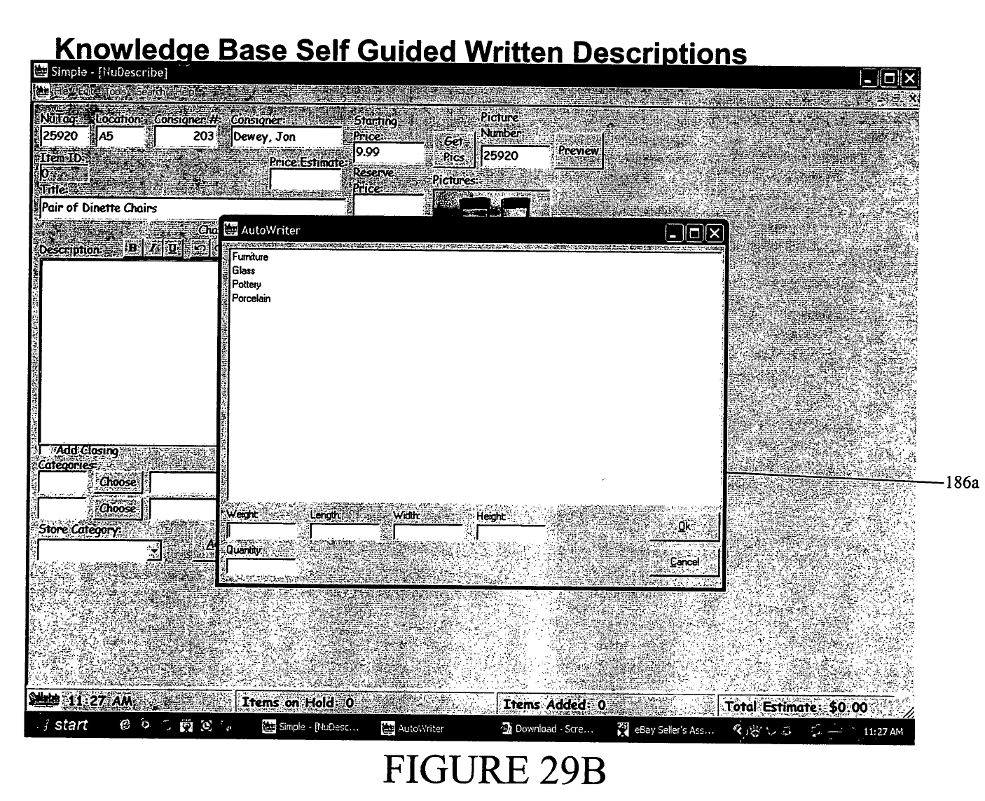

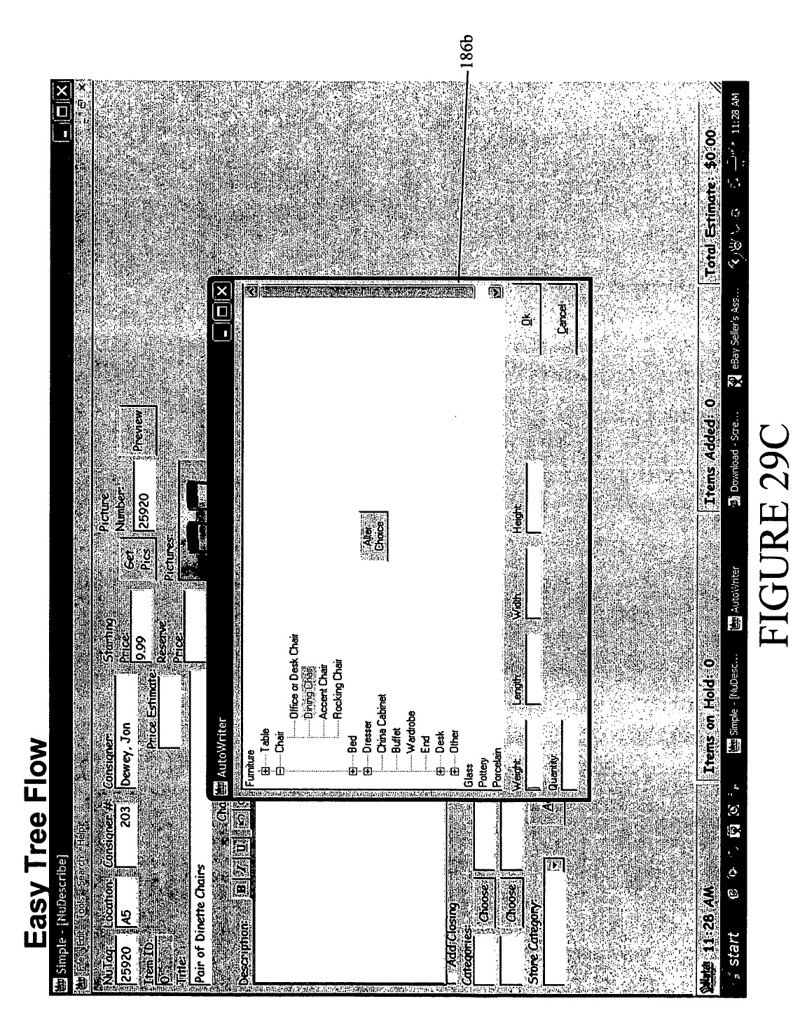

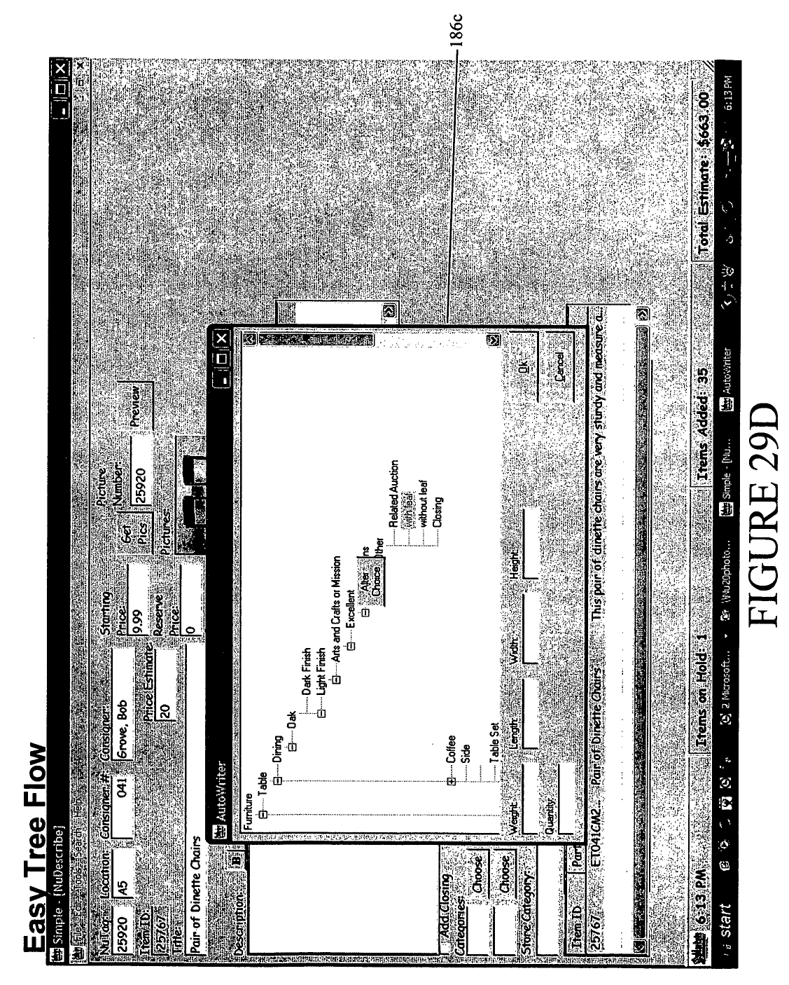

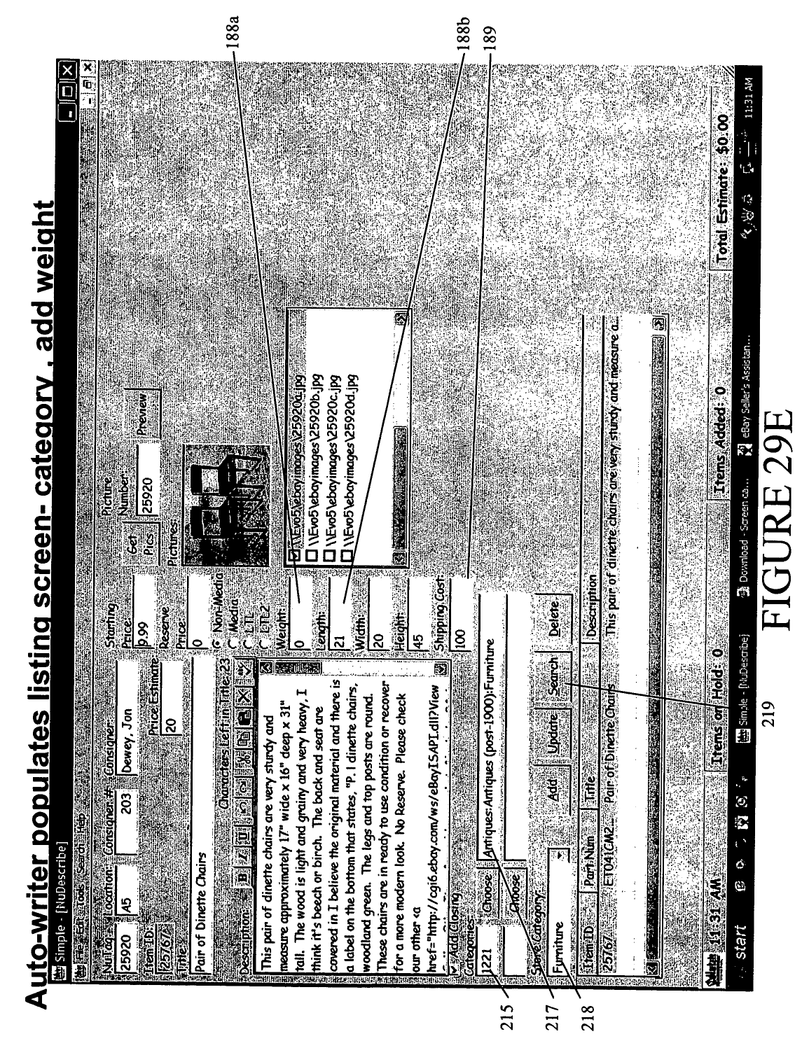

Description Authoring. Description authoring 171 is founded around a dynamic knowledge base allowing the user to quickly create an item description utilizing the online auction categorization system. The knowledge base approach provides an environment where a user (Product Manager) who does not posses knowledge about the item can create an accurate description by providing pre-determined information about the item based on requests in the autowriter interface 185. Using auction categories as the root of the knowledge base allows the user to create an accurate description that maximizes auction traffic and increases the amount of the final bid. This process is illustrated in FIGS. 29A-29E.

Autowriter 170 is used to generate an item description from a dynamic knowledge base using pre-written phrases interspersed with item specific physical attributes such as construction material(s), color, length, height, depth, weight, etc. Users select the pre-written phrases (templates) by navigating through a collapsible menu 186a, 186b, 186c in FIGS. 29B-29D with selections based on auction categories. Prewritten phrases may advantageously provide provence or background information to increase purchaser interest. The Autowriter process is shown in FIGS. 29A through 29E. Thus, in the example of FIG. 29A, the user populates the title with the descriptive phrase “Pair of Dinette Chairs.” As shown in FIG. 29B, the collapsing menu description contents selector step 190 activates an initial four item menu 186a in FIG. 29B. When the furniture category is selected, the menu expands to list types of furniture as reflected in autowriter screen 186b in FIG. 29C. If a table were selected rather than a chair, autowriter screen 186c shows the increasingly detailed description generated by the dynamic knowledge base. By utilizing the collapsing menu description selector of the autowriter screens 186a-186c, the user searches for 192 and locates 191 the correct template which then generates standard prewritten phrases to generate a descriptive paragraph. The description must be proofread 194 and corrected 196 until acceptable 195. The user then selects from the available images, the image that will appear initially in the auction listing 172 by marking an appropriate box 187 in FIG. 29A.

Shipping Method Selection. The shipping method determination tools utilized within the system simplify the complex task of choosing the most appropriate carrier to maximize safety in transit, revenue from shipping, and customer acquiesce. The shipping method tool 173 in the Autowriter module 170 compares item-specific physical properties to shipping criteria dictated by the carriers in order to determine the most appropriate carrier. This tool allows each storefront location to function without the need for a separate shipping liaison.

The system recognizes several methods of shipping (Media Mail, Non-Media, LTL 1, LTL 2, LTL 3, and LTL 4). The shipping method used is selected based on physical characteristics of the item. Choosing the shipping method also determines the carrier (UPS, Overnite, USPS, FedEx, DHL, etc.) based on carrier specific regulations. Qualifying media is shipped via USPS Media Mail™. Other items up to 130″ girth are shipped via courier. Oversized items are palletized and shipped LTL (Larger than Truck Load). Shipping method and carrier information is exported in HTML format into the shipping information portion of the auction page.

Shipping Cost Calculation. The shipping calculation utility within the system automates the task of calculating shipping charges for auction items across several carriers. Using information gleaned from the shipping method tools 173, shipping cost is calculated and may be automatically exported in HTML format into the shipping charges portion of the auction listing.

Customer shipping charges are calculated based on the carrier and physical characteristics of the item. The physical dimensions are entered into the interface (188a, 188b in FIG. 29E) and shipping charges are automatically calculated for Media and Non-Media packages. LTL packages have varying costs determined by weight and distance to destination. These charges are calculated by the shipping technician as shown in FIG. 12. In the representative shipping determination flow chart of FIG. 12, the dimensions are input 190 and analyzed first for dimensional weight criteria 191, in which case they are processed according to the dimension weight limitations 206-211. Alternatively, the weight is also input 192 and if less than seventy pounds 193, courier shipping charges are automatically calculated 194. Alternatively, if greater than seventy pounds, an appropriate weight range is selected 195-199, an appropriate larger than truck load shipping category determined 200-204 and a storefront specific larger than truck load pricing document 205 is referenced to calculate the shipping cost which is entered either automatically or manually in the appropriate field 189 as shown in FIG. 29E.

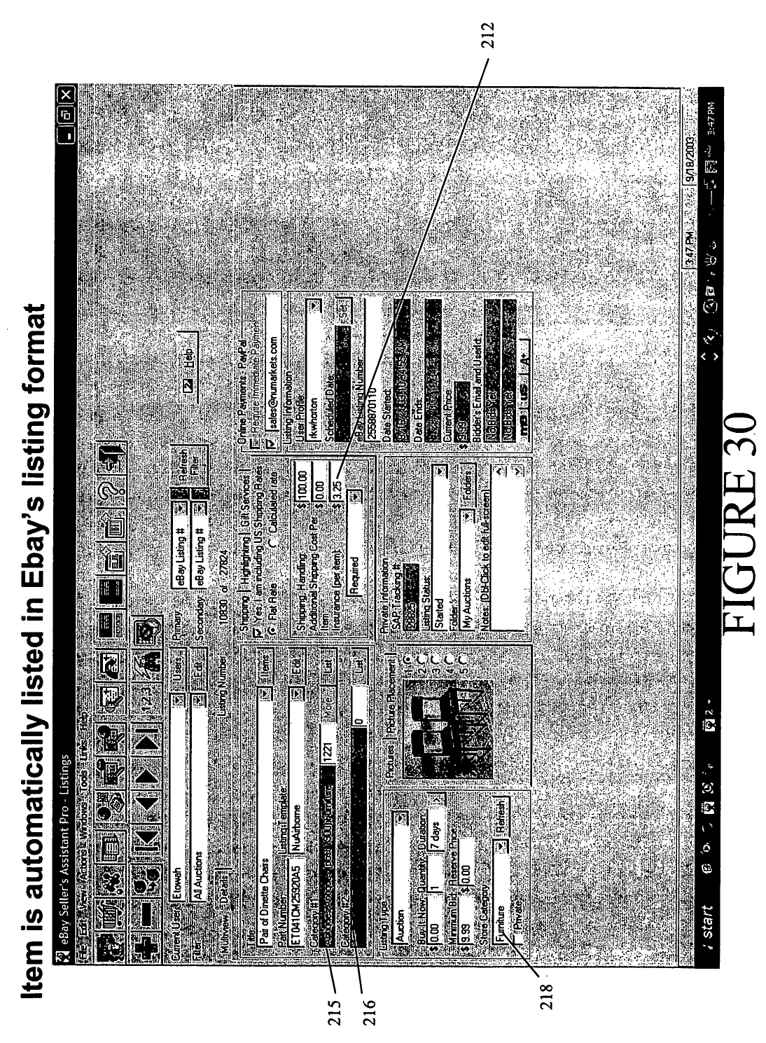

Shipping Insurance Calculation. Certain methods of shipping and certain items require shipping insurance. Insurance charges are determined automatically based on carrier and item valuation 212 (shown in FIG. 30). Insurance charge information is exported in HTML format into the insurance information portion of the auction page.

Listing Category Selection. The auction category determination tool 174 built into the Autowriter module 170 allows the user to determine the most appropriate auction category 223 in which to list the item. Providing a collapsible menu 217 within the interface allows the user to choose the correct category quickly within the application and allows unknowledgeable users to determine the category accurately. For instance, Auction Items on eBay are classified by a category system. The category determination tool 174 can use the same categories, in a collapsing tree format, as eBay and allows the user to determine the proper listing category 215 as shown in FIG. 30. Also provided is a category search utility 219 (FIG. 29E) that allows the user to search the category index 222 for the most appropriate category for an auction service. The user simply references any notes provided from the consignor, opens the category selection menu 221, searches for the appropriate category 222 either through collapsing tree format or search utility 219 (FIG. 29E), and selects the appropriate category 223. If desired, the item can be classified in a second category 216 (FIG. 30) to improve buyer search accessibility.

Store Category Selection. The interface provides an efficient method of determining the eBay store category the item will be listed under. An eBay store provides a single area for viewing all of an eBay sellers items. These items are classified by “Store Categories” which are dictated by the seller. A drop-down menu 218 containing the store categories is provided. The user determines the most appropriate category and selects it from this menu. Listings within the eBay store provide increased auction traffic and increase the final value of the item. An autopost module 225 then completes the storefront's pre-auction activity.

End of Day. Once the auction listing information has been completed, the information is queued on the storefront local server 232 to await the End of Day process 226. This juncture completes the participation of the storefront until the item is packed and shipped/picked-up unless there are item specific inquiries. The End of Day process 226 is performed daily at each storefront. Storefronts upload an XML data file 233 to the central server containing the information from each day's auctions. This data is used by the autoposting utility 228 to publish the auctions online.

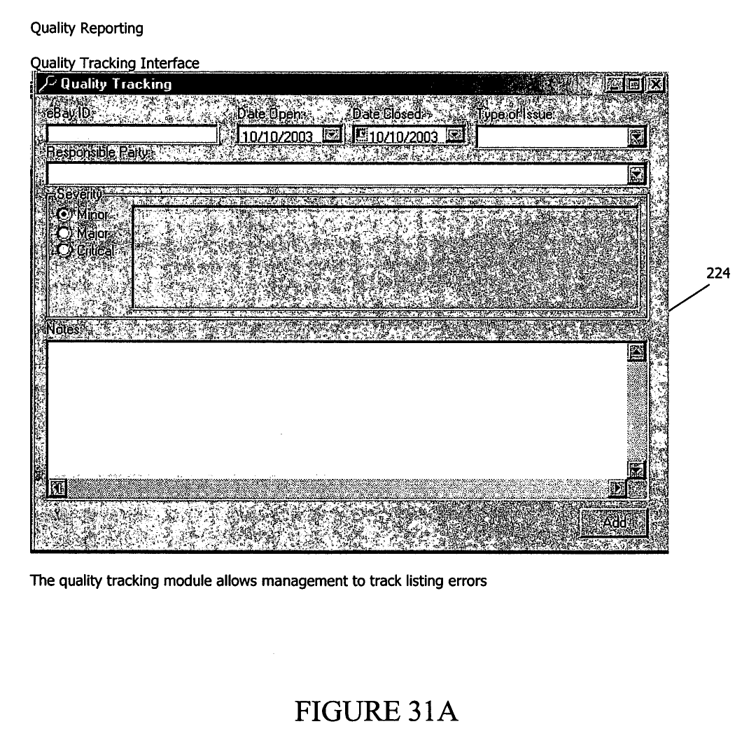

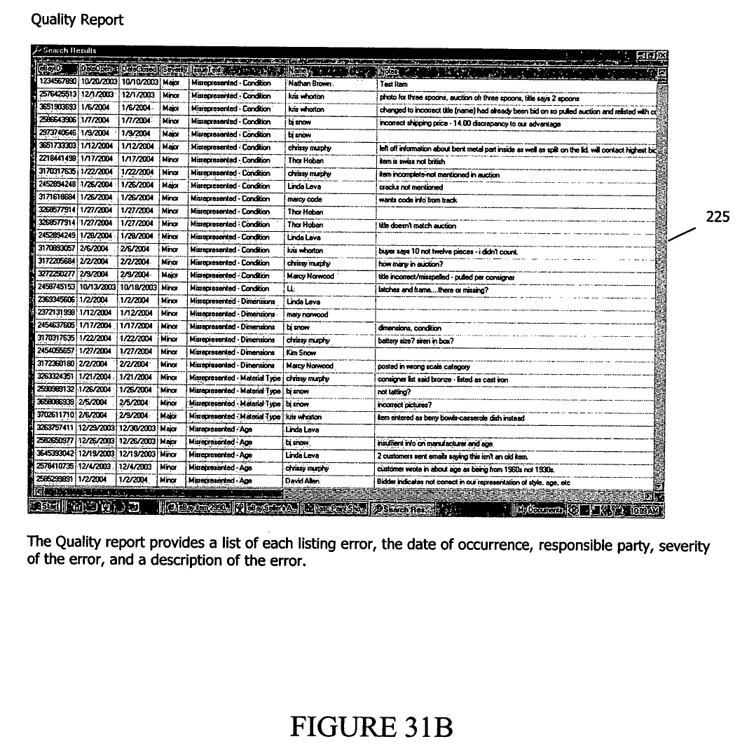

Quality Review and Inspection. Data received from storefronts during the End of Day process is reviewed using a double sampling method to insure that the listings are correct. Items are proofread for grammatical accuracy and completeness of description. Listings are checked for prohibited or otherwise illegal auction items such as firearms or recalled products. A quality tracking interface 224 creates reports 225 based on total accuracy and compares the results to other storefronts providing a measure of performance as shown in FIGS. 31A and 31B.

Autoposting Utility. The Autoposting utility 228 communicates with the auction service through an automated process and creates auctions without user input. Automating the posting process bypasses the complex traditional auction posting processes and 3^{rd} party software packages. Automated posting allows the storefront to focus on primary revenue generating functions and minimizes intra-company communications.

End of Day Data Compilation. Data uploaded by storefronts during the End of Day process is compiled on the central database 229 to expedite auction publication 231. The data collected consists of the information entered into the interface at the storefront and a query for previously listed but unsold items for relisting 230. Collecting and pooling information packages from individual storefronts allows for an infinitely scalable process without the need for enterprise class data systems at each storefront.

Autopost. The Autoposting utility is an automated utility 228 located on the central server that periodically queries uploaded storefront information for items that have not been posted. The Auto-Post module then contacts the online auction and posts qualifying items 231.

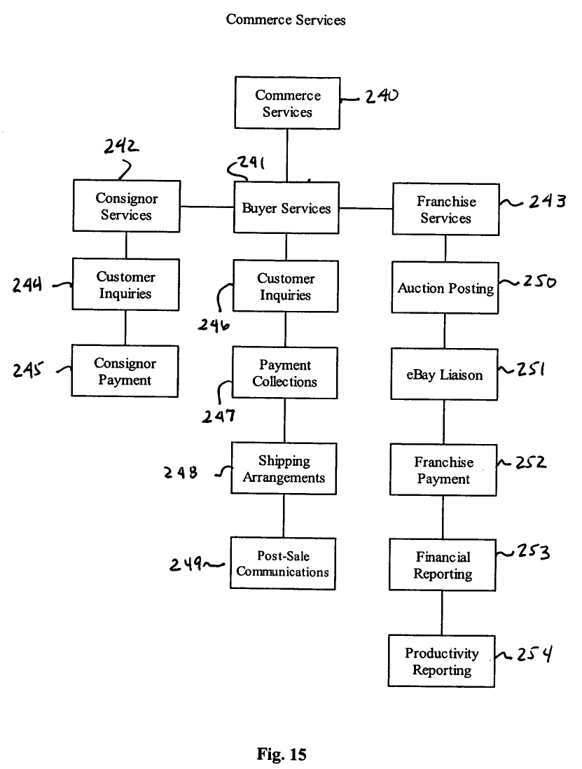

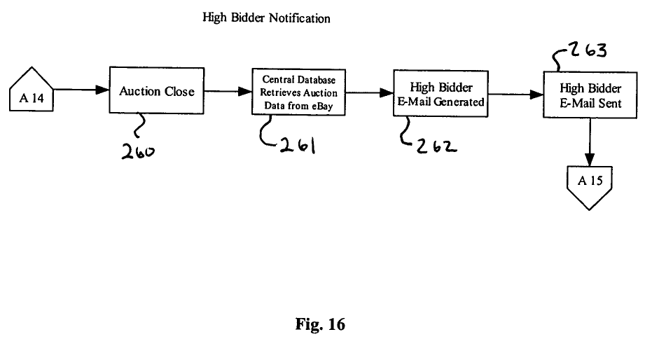

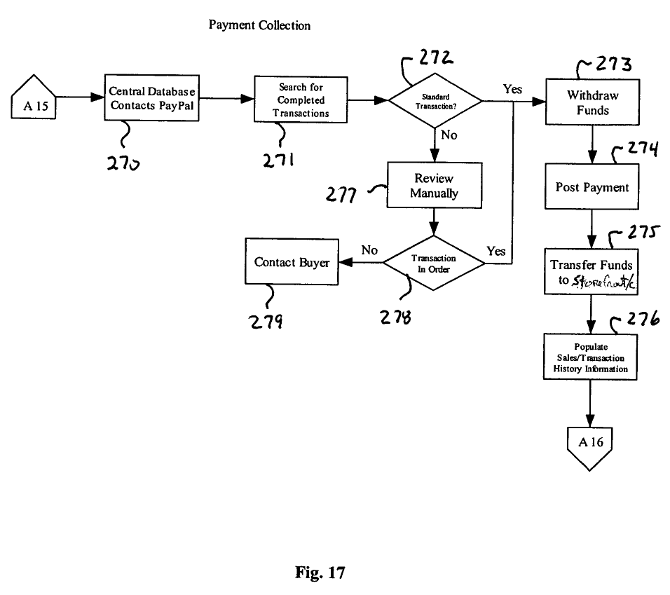

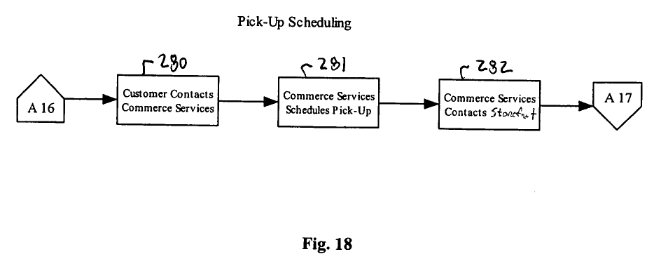

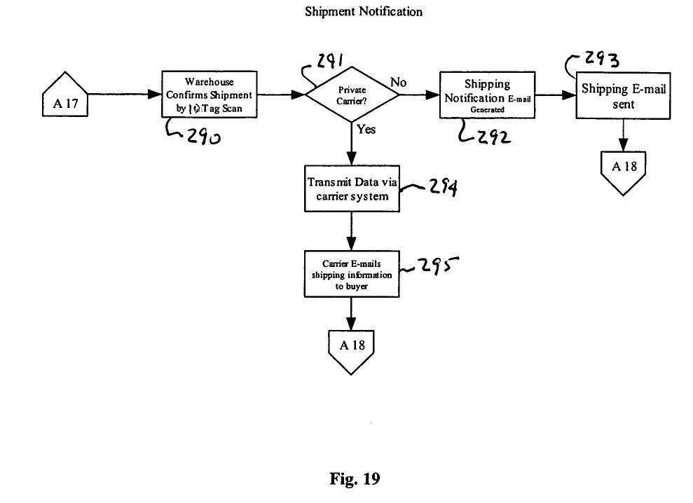

Commerce Services Module. The core of the business model is the centralization of commerce services acting as a centralized communications hub between the company and its storefronts, whether franchised or company owned, and customers. The Commerce Services Module 240 can be divided into Buyer Services 241, Consignor Services 242, and Franchise or Storefront Services 243. Customer inquiries and financial transactions all take place through centralized commerce services as shown in FIG. 15. Managing customers and financial transactions through a central location provides a consistent brand image and allows storefronts to focus on auction processes.

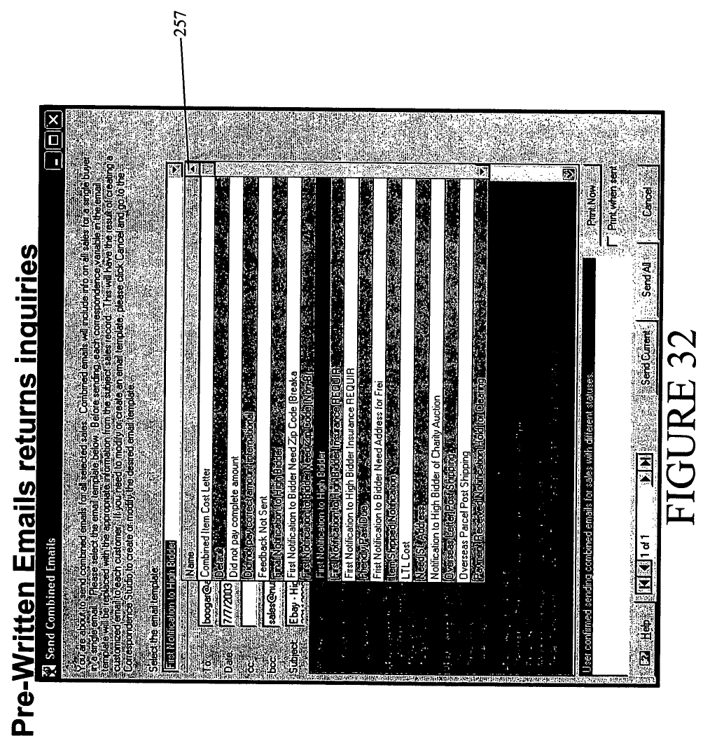

Inquiry Management. Commerce services 240 manages all customer inquiries 244, 246. Phone inquiries are answered by Commerce Services. Email inquires are disseminated amongst Commerce Services based on addressee and the nature of the inquiry. Item-specific questions are forwarded to the originating storefront. Commerce Services maintains an always open communication channel with storefronts utilizing instant messaging allowing rapid communications with maximum transparency. Pre-written emails as shown in FIG. 32 facilitate responses to inquiries and the notification of payment collection processes. A drop down menu 257 is provided with pre-written templates that are automatically populated with appropriate information from the applicable auction.

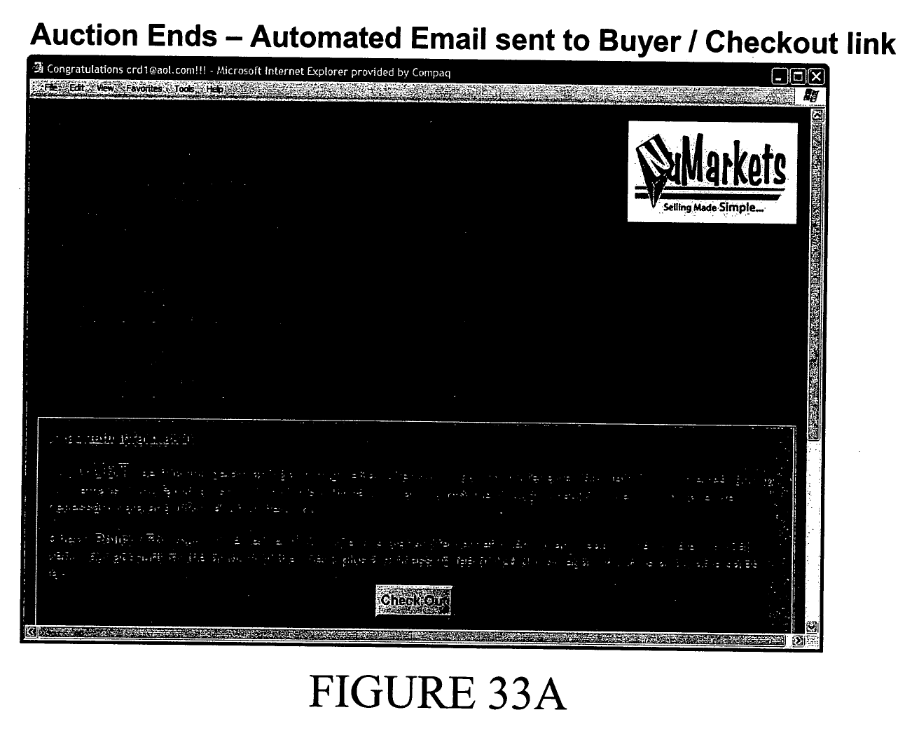

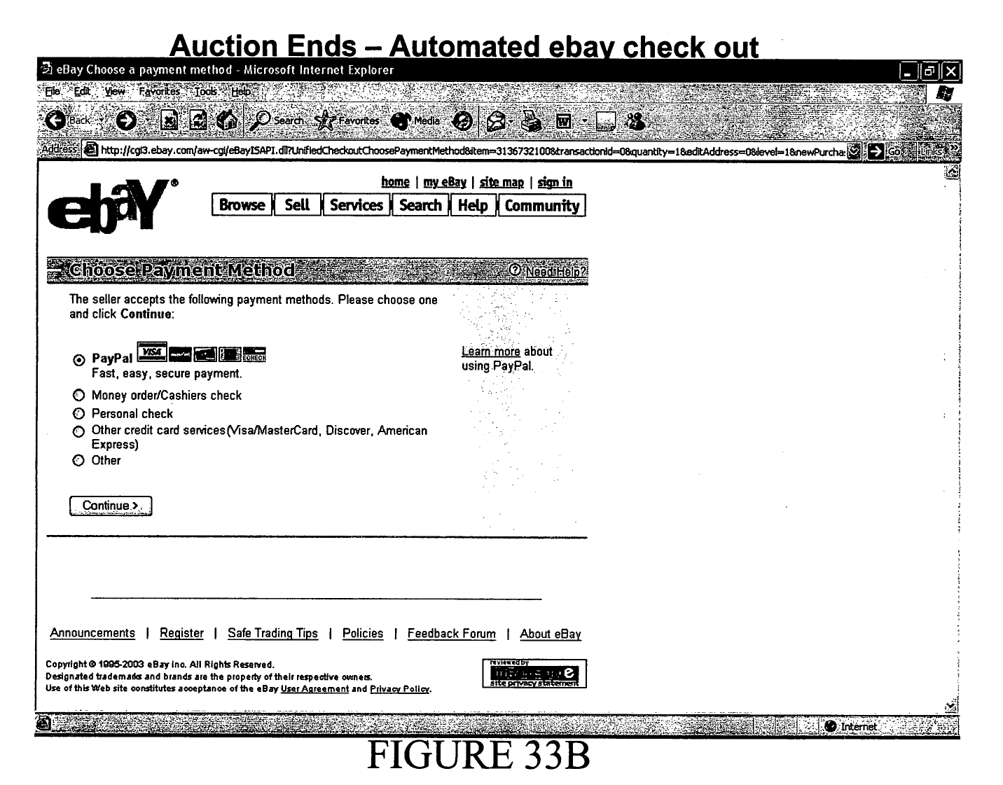

High-Bidder Notification. The high-bidder notification process provides an avenue of communication between the system and the buyer while minimizing customer inquiries and the workload of commerce services. At auction close 260 the high-bidder is sent an email 263 containing information about the auction that has been returned in part from the online auction marketplace 261. The notification email includes: Auction number, auction description, shipping information, insurance information, applicable tax information, payment remittance information, sale tracking information, and a link to the eBay 262, as shown in FIGS. 33A and 33B, or other auction checkout. The high-bidder notification accelerates the payment and order fulfillment process from an average 28 days to payment to less than five (5) days.

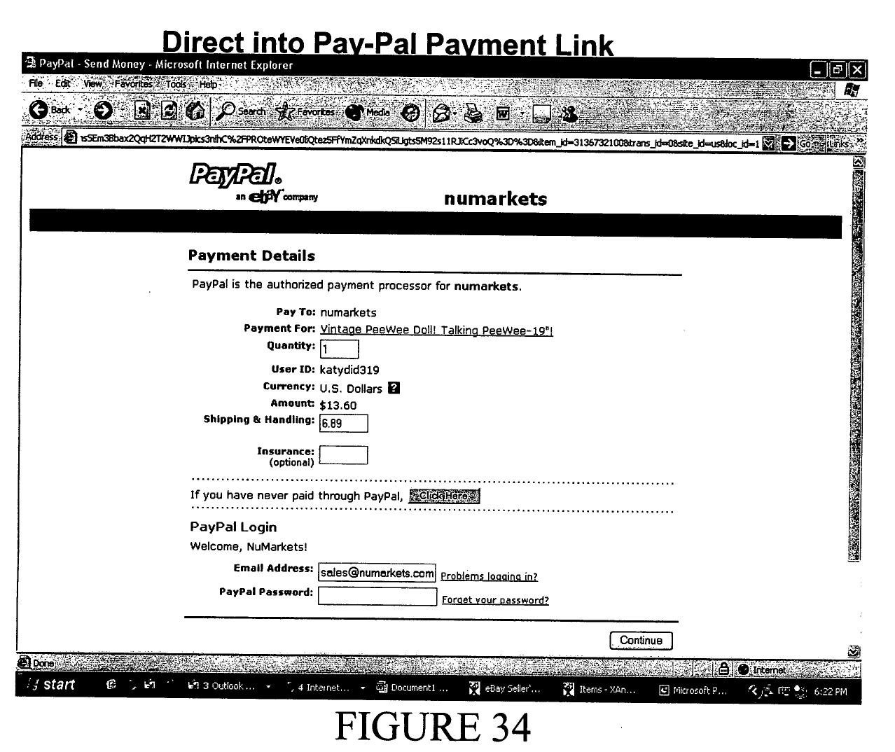

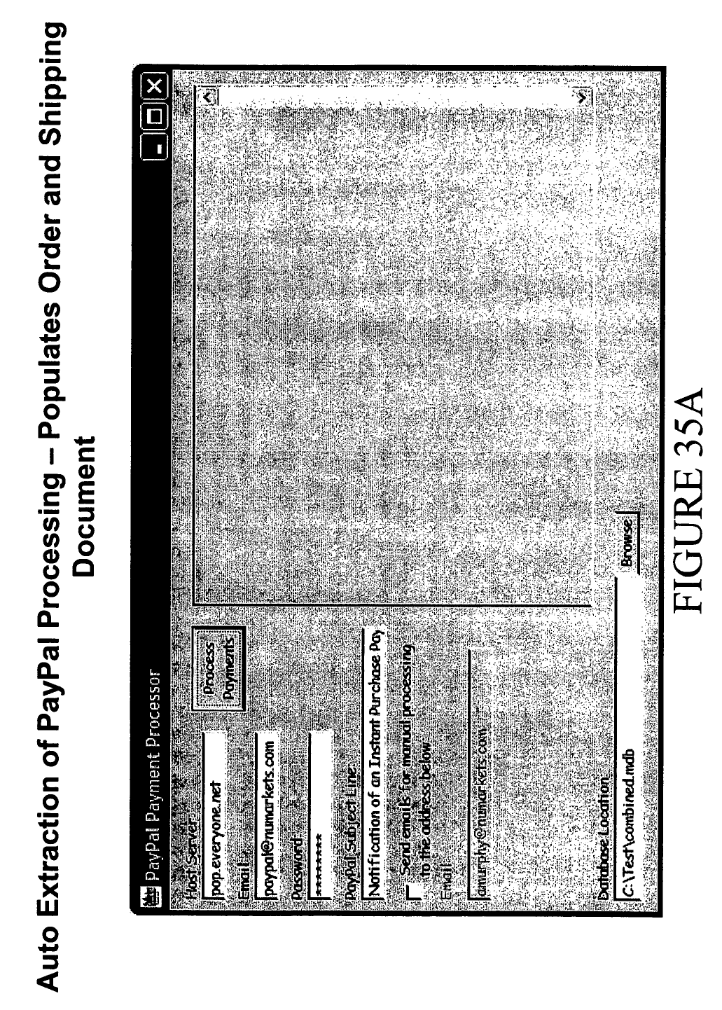

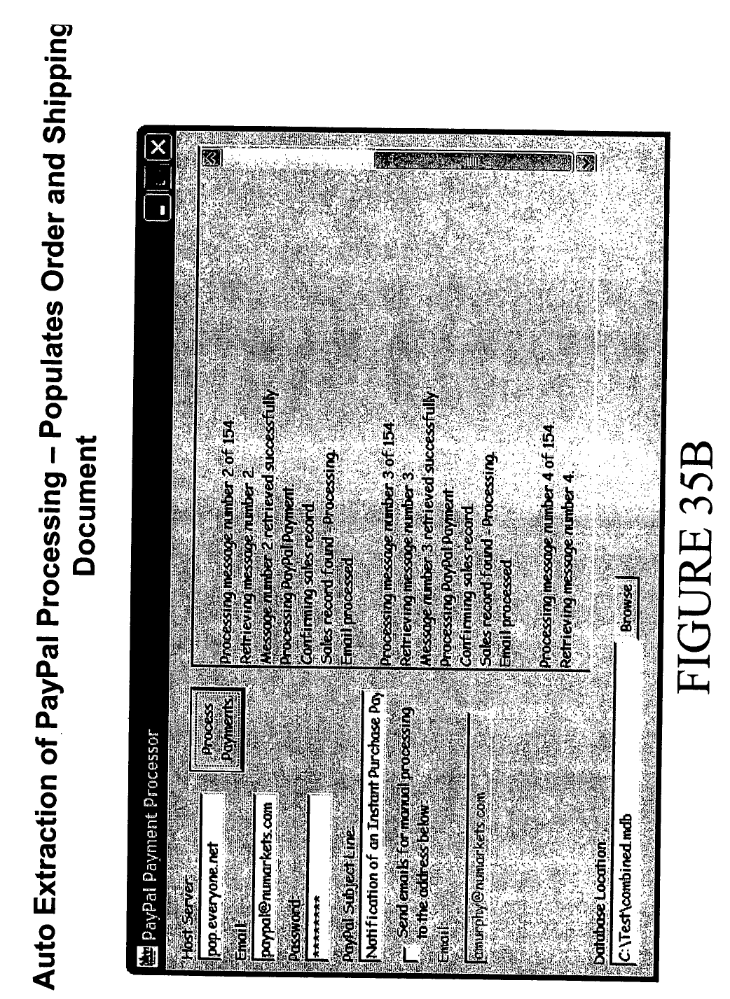

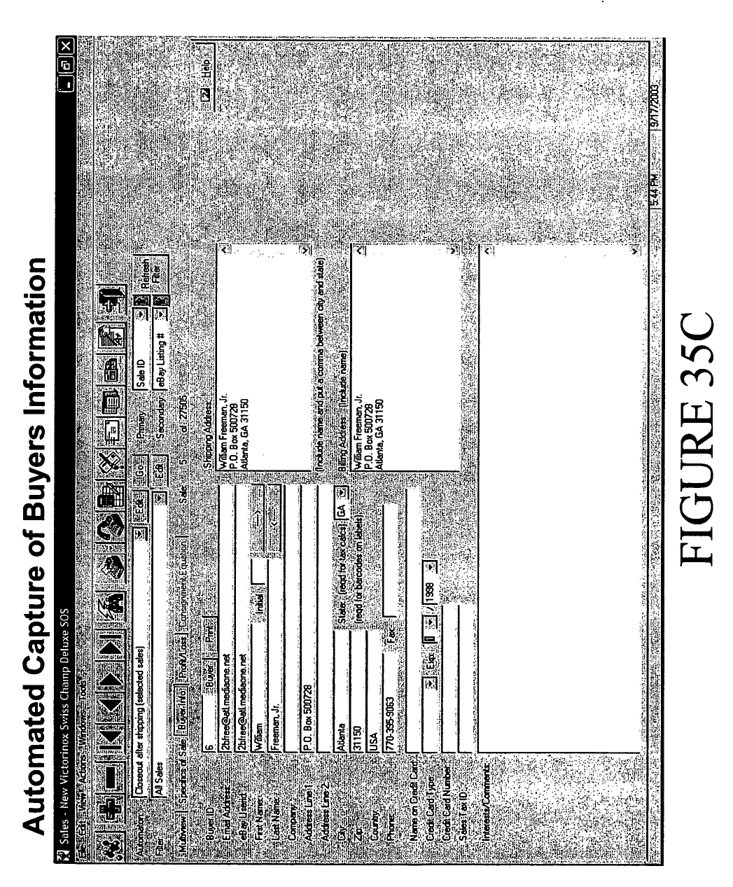

Payment Collection. Payment is collected 247 either electronically via PayPal (www.paypal.com), as shown in FIG. 34, or other electronic payment intermediary or wire transfer, delivered by mail as a money order or check or in person from the buyer in the event of a local pick-up. PayPal payments can be collected and transferred automatically upon deposit. Money order and check payments are dependant on mail transit times and bank approval policies. The electronic intermediary payment extraction module automatically processes electronic payments while identifying suspect transactions for manual review as shown in FIGS. 35A and 35B. In addition, payment collection from PayPal or other intermediaries may permit automated capture of purchaser information as shown in FIG. C. The PayPal extraction module contacts the PayPal site 270 and queries for completed payments 271. Completed payments are matched by Auction Number to the Unpaid Auction index 272 on the Central Database. Funds are then transferred 273 and the transaction marked as paid 274. During payment processing transactions are reviewed for non-standard factors 272. Insufficient/partial payments, international shipments, or any other non-standard transactions are identified and reviewed manually 277. After collection, shipping information is sent electronically to the storefront 276, and funds may either be sent electronically to the storefront or sent electronically or by post to the consignor 275. The payment module also is designed to electronically capture buyer information as shown in FIG. 35C to facilitate automatic population of shipping documents and for historical information 276.

Pick-up Scheduling. Under certain circumstances, customer proximity, size of item, shipping costs etc., customers may decide to pick the item up at the franchise instead of shipping it. Upon a customer contact 280, Commerce services schedules the customer pick-up 281 and communicates this information to the relevant storefront 282.

Shipment Notification. Upon shipment customers are sent an email 293 to confirm shipment. This email is generated 292 containing auction title and number for reference, method of shipment, date shipped, and tracking information for qualifying parcels. (USPS Media Mail does not provide tracking services). This email also includes information on reporting a damaged shipment and making a claim. Parcels shipped via Airborne and some other private services are emailed tracking information by the carrier 295 after receiving data from commerce services 284.

Consignor Payment. The system calculates the total amount of the check but referencing completed auction transactions and the consignor's number. This information is output to the financial software where a check is printed and given to the consignor 245. The check is preferably picked up by the consignor at the storefront, but may be mailed or funds transferred electronically by either commerce services or the storefront.

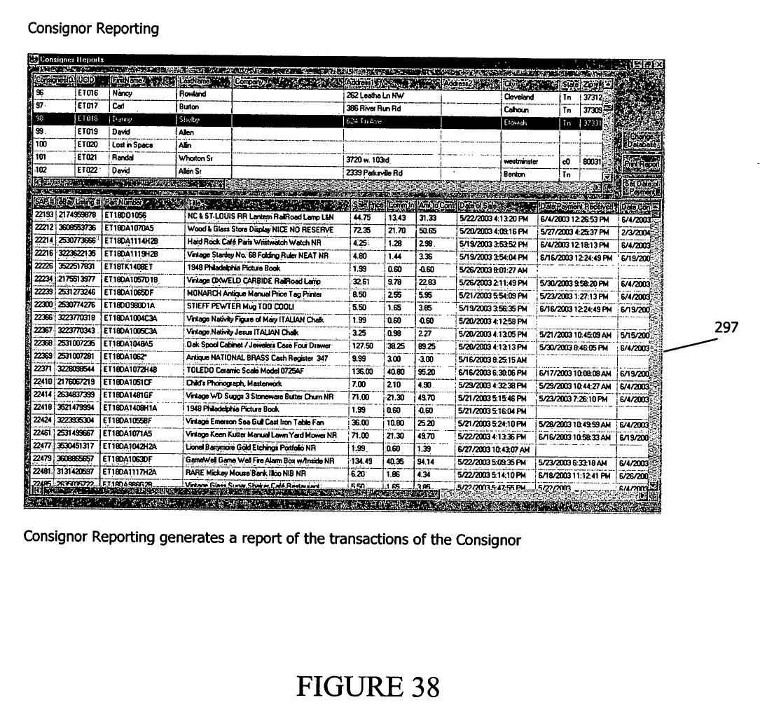

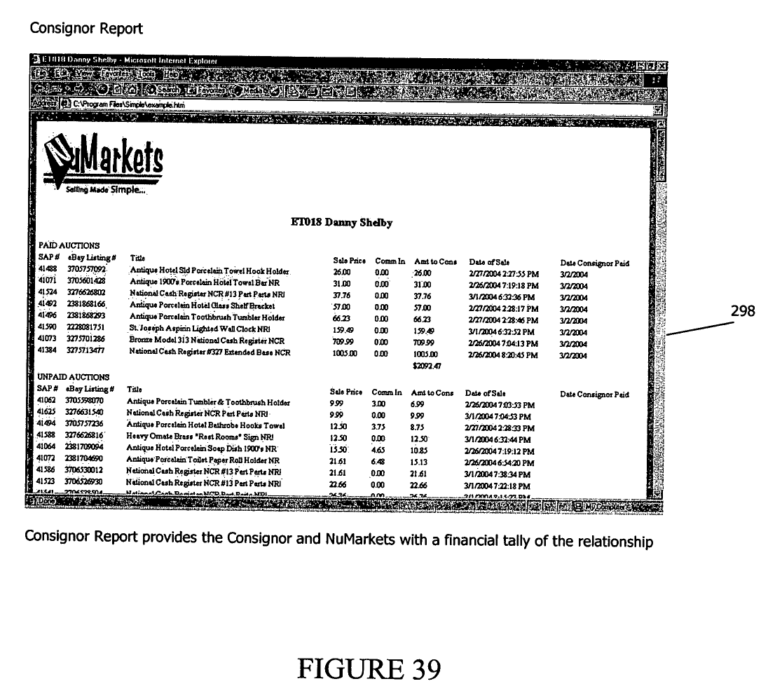

Consignor Reporting. Commerce Services automatically generates a report (Consignor Report) identifying the items being paid for, sale price, commission paid, amount paid to Consignor, the average selling price (ASP), date of sale and the date the consignor was paid. The report 297 also contains status information about items that have sold but have not yet been paid for (Unpaid Items), items that have not sold (Unsold Items), and a compilation of all items sold during the last 30 days as shown in FIG. 38. Issuing the report provides a physical receipt for the Consignor; maximizing brand experience and brand exposure. The consignors may also access the report online and follow the online auction of their item, as shown by the representative browser displayed in formation 298 in FIG. 39.

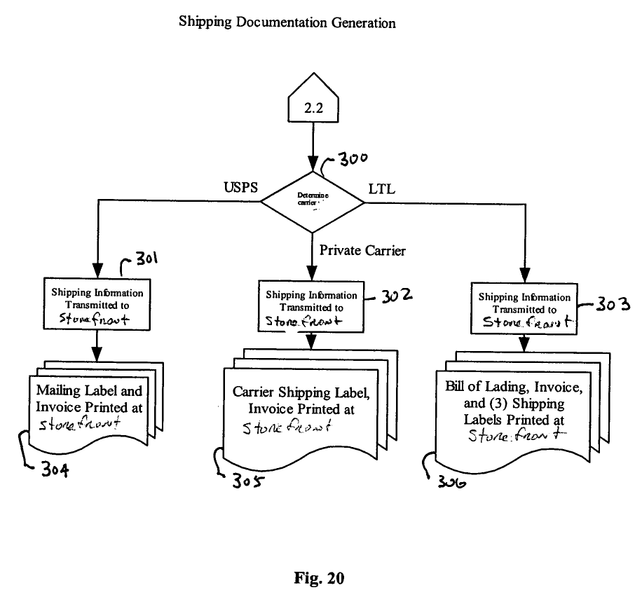

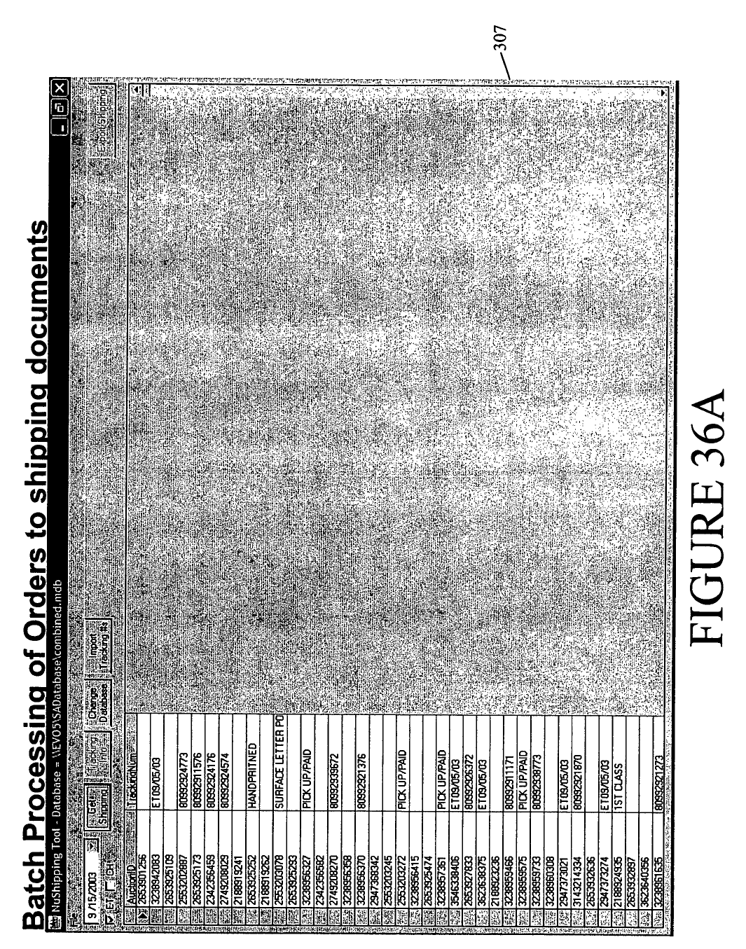

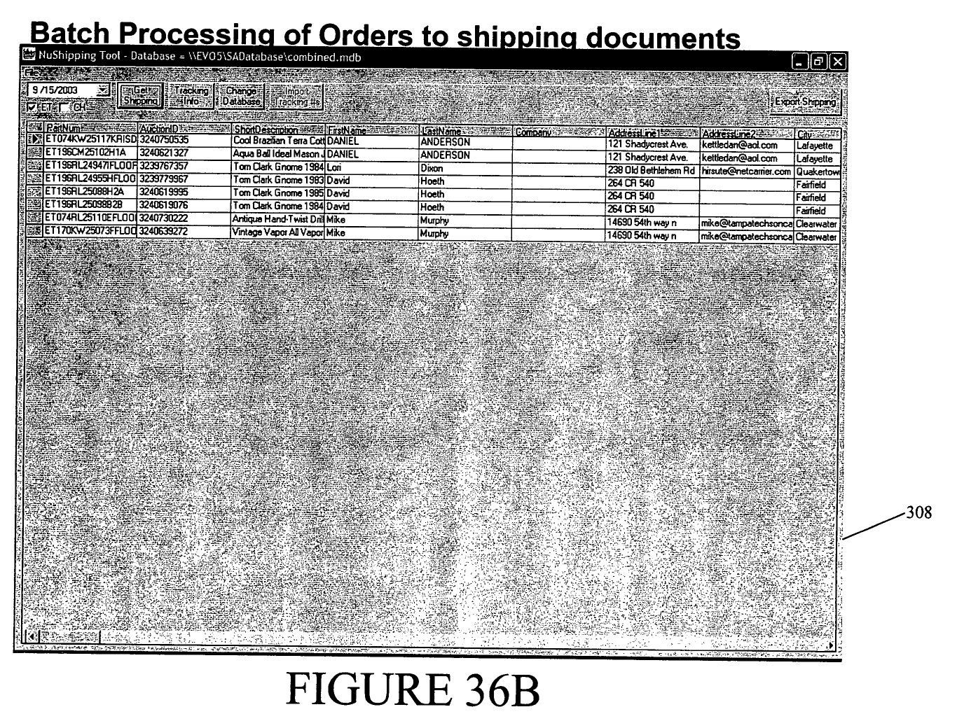

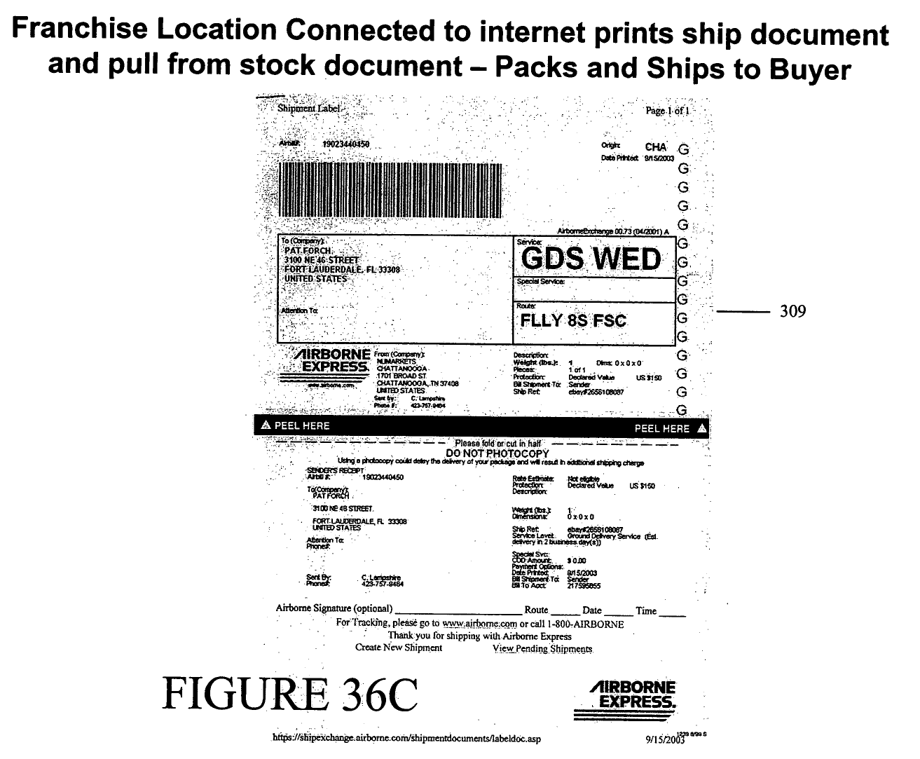

Shipping Documentation Generation. Upon confirmation of payment by Commerce Services, shipping documentation is generated at the individual storefront based upon information transmitted for commerce services. FIG. 36A reflects a screen 307 displaying unshipped items. FIG. 20 reflects the determination of the carrier 300. The transmittal of shipping information to the storefront 301-303, and the priority of shipping labels such as the private carrier label 309 of FIG. 36C at the storefront 304, 306. Referencing the information input during the description creation phase, the system generates the documentation required by the carrier, as reflected in FIGS. 36A through 36C.

Warehousing Module. The system includes a Warehouse Management System (WMS) Module 30 developed specifically for managing large quantities of unique items on a large scale using ID Tags. Individual storefronts are assigned a unique location code which precedes the item identifier (NuTag) allowing each storefront to generate an exclusive set of identifiers. Storefront specific information is stored at the storefront database and a copy of the information is uploaded to the central server daily where it is referenced by the storefront location code. In this manner individual storefronts retain control of actual warehousing with the central database acting as an archive. The warehouse area is preferably contiguous to the storefront so that little unnecessary movement of the consigned items is required. Warehouse space must typically be adequate to hold two to three weeks of consigned items.

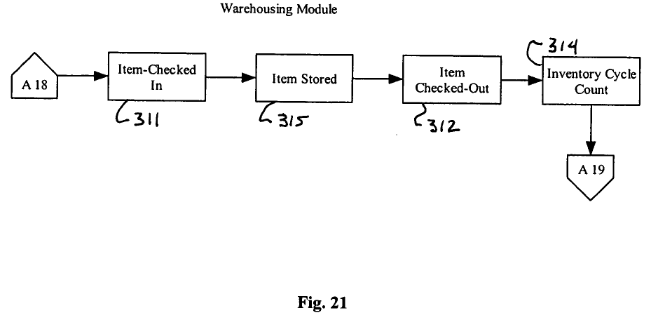

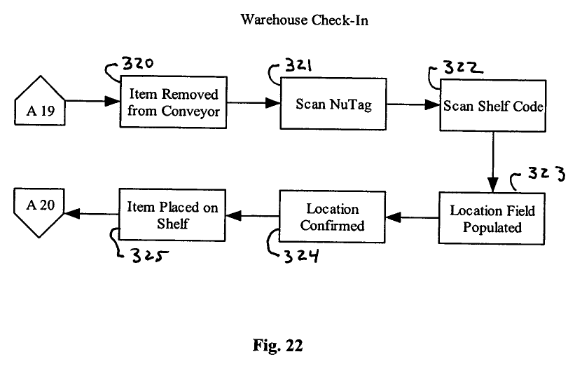

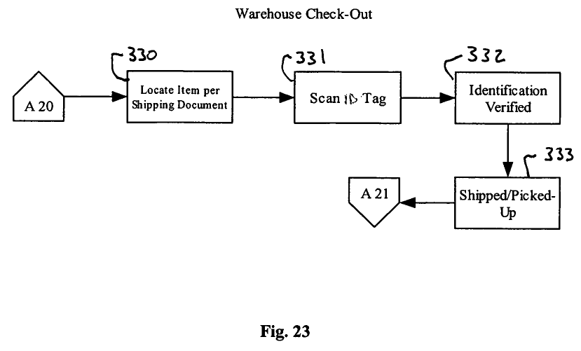

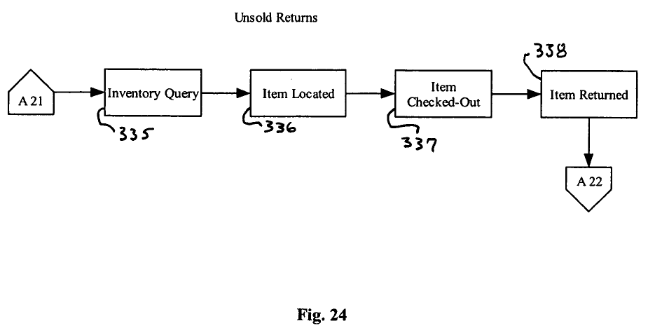

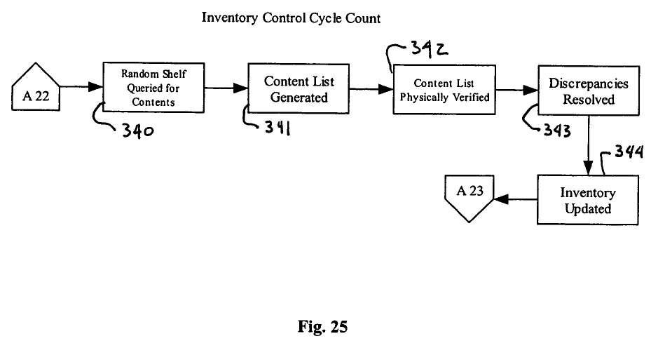

Inventory control and warehousing are controlled by ID Tag and shelf data preferably collected via a Code 39 barcode or RFID system. The warehouse is divided into multiple storage areas (shelves) that each have a unique location code. The location code is visible on each shelf in both machine and human-readable format. In the most general terms, items that have been processed to create auction listings are checked into the warehouse 311, stored during the auction 315, checked out for shipment to buyer or return to consignor 312, and inventory lists are generated for verification 314, all as shown in FIG. 21.

Item Check-In. Items with completed descriptions are ready for check-in 311 and may be transported via conveyor to the warehouse area to await storage. Item on the conveyor is removed 320 and scanned 321. The Location Code listed on each shelf is scanned 322, populating the “Location” field 323 in the Autowriter interface. Location is confirmed at the warehouse terminal 324. Item is placed on the appropriate shelf 325 to await shipping or return to the consignor. Item descriptions are then ready for quality assurance and posting.

Item Check-Out. Upon confirmation of payment by the commerce services, items are scheduled for pick-up by the customer (buyer) or appropriate shipping documentation is generated. A Warehouse Technician locates the item by referencing the ID Tag Number in the local database 330. The item is collected and a scan of the actual ID Tag verifies the correct item. Once the item is identity verified 332, the Warehouse Technician confirms shipping time and date 333 by clicking the “Shipment/Pick-Up Confirmed” button in the warehousing interface.

Unsold Item Returns. Unsold items are items which have been listed two (2) times and have received no bids. These items are returned to the consignor. A periodic list of unsold items and their locations is generated at the storefront by query of the local database 335. Items are located and removed from the shelf 336 and identification verified by scanning the ID Tag. Items removed from storage for return to consignors are checked out 337 and confirmed “Returned to Customer” and are returned 338 with the time and date of return entered into the local database by clicking the “Returned to Customer” button in the warehousing interface.

Cycle Counting. Control checks of inventory are initiated daily by querying 340 generating an inventory list of a random shelf 341. The shelf inventory is physically verified 342. Any discrepancies are resolved 343 and the inventory data is updated 344.

Analytical Management Module. A report writer provides tools for analyzing productivity and performance information 350 to aid in process improvement and decision making. Reports are compiled for each storefront at the local and corporate levels with condensed reports executive analysis. Executive level data can be reported in any number of formats as per situational requirements by utilizing the post-relational data organization tools within the system.

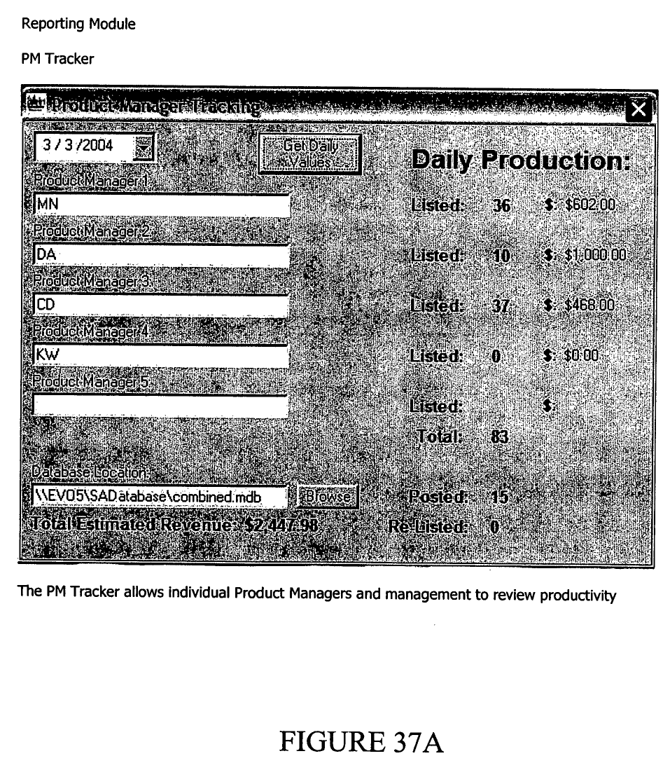

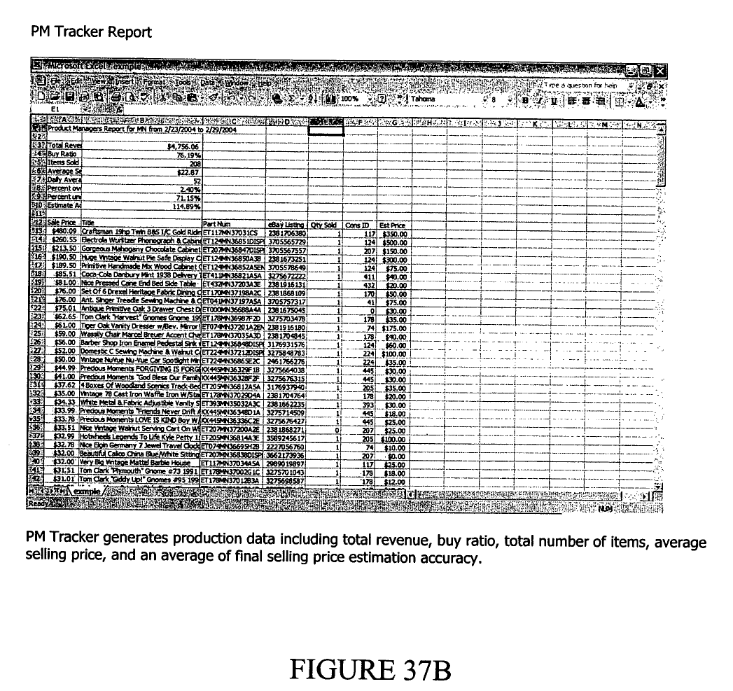

Productivity Reporting. Productivity amongst storefront employees is measured and tracked by the PM (Product Manager) Tracker and reported as raw daily performance data (number of items listed) and compiled, within a user defined time window, to provide a number of measurements as reflected in FIGS. 37A and 37B. Individual Product Managers input his or her initials, or other ID code, into the PM Tracker interface; PM Tracker organizes data using the ID codes of the Product Manager as a reference. At the time an item description is created Product Managers are required to estimate the final selling price of an item. These estimates are averaged to provide a quantifiable measure of the Product Managers product knowledge. Data provided by PM Tracker and may include among other subjects:

Total Revenue: Total revenue generated

Buy Ratio: Number of items sold compared to the number of items listed

Items Sold: Number of items actually sold

Average Selling Price (ASP): Average selling price for listed items that sold

Daily Average: Average number of items listed daily

Percent Over: Percentage of overestimated items

Percent Under: Percentage of underestimated items

Estimate Average: Percentage of overall estimate accuracy

Time To Post: Average time to post for each auction

This information can be generated in a number of formats depending on requirements. Productivity reports can be generated for an individual Product Manager or all of the Product Managers for an individual storefront or all Product Managers using the system for local and central analyses. Reporting time windows can be for the past week or user defined dates. PM Tracker data can be output in standard Microsoft Excel format.

Shipping Productivity. Shipping department performance is a critical component of storefront/company performance measurement. Shipping department performance is quantified to provide analysis tools necessary for gauging storefront/company performance. The Shipping Department Performance report records:
Daily total packages shipped
Weekly total packages shipped
Daily and Weekly Averages over a user defined time window
Number Packages Behind
Total Number Packages Requiring Shipment
   Shipping performance reports may be compiled at the individual storefront and at the central level for local and executive analysis.

Revenue Reporting. Revenue reports for each storefront are generated at the local and central levels on a weekly or other periodic basis providing measurements of storefront and company financial performance. Revenue data is reported in separate segments for each revenue generating component.

Although preferred embodiments of the present invention have been disclosed in detail herein, it will be understood that various substitutions and modifications may be made to the disclosed embodiment described herein without departing from the scope and spirit of the present invention as recited in the appended claims.

1. A system for the consignment selling of items into an online auction market place comprising:
(a) a plurality of intake nodes for receiving items from consignors;
(b) a commerce service center providing commerce services to said plurality of intake nodes;
(c) software for recording the consignor identity and a unique item identifier at the intake nodes;
(d) imaging equipment and software for capturing images of consigned items and associating the images for each item with the unique item identifier at the intake nodes;
(e) a knowledge database at the intake nodes to automate the process of describing consigned items;
(f) a communications network between the intake nodes and commerce service center for transmitting unique item identifiers and associated images and descriptions to the commerce service center and the transmission of auction results, payment information and shipping information to the intake nodes;
(g) a database maintained by the commerce service center containing information for consigned items from the plurality of intake nodes; and
(h) a communications network between the commerce center and the online market place for the uploading of auction information to the online market place and the transmission of auction results to the commerce center.

2. The system of claim 1 wherein . . .

3. A method of managing the consignment sales of items in an online auction marketplace comprising the steps of:
(a)
